(19) United States
(12) Patent Application Publication
(10) Pub. No.: US 2024/0362447 A1
(43) Pub. Date: Oct. 31, 2024

(54) IMAGE-FORMING SYSTEM, METHOD, IMAGE-FORMING APPARATUS, AND SERVER APPARATUS

(71) Applicant: CANON KABUSHIKI KAISHA, Tokyo (JP)

(72) Inventors: SHIMPEI ISHIKAWA, Kanagawa (JP); MAREHIKO HIRAJIMA, Kanagawa (JP)

(21) Appl. No.: 18/767,549

(22) Filed: Jul. 9, 2024

Related U.S. Application Data
(63) Continuation of application No. PCT/JP2022/040368, filed on Oct. 28, 2022.

(30) Foreign Application Priority Data
Jan. 20, 2022 (JP) 2022-007273

(51) Int. Cl. G06K 15/00; G03G 15/00; G03G 15/08; G06K 15/14

(52) U.S. Cl. CPC G06K 15/407; G03G 15/0865; G03G 15/5016; G03G 15/5091; G03G 15/556; G06K 15/14

(57) ABSTRACT

An image-forming system includes: an image-forming apparatus configured to form an image on a recording medium using a consumable material in a container device; an inhibiting mechanism capable of inhibiting supply of the consumable material from the container device to the image-forming apparatus or insertion of the container device into the image-forming apparatus; an obtainment unit configured to obtain a code unique to the container device in a state where the inhibiting mechanism inhibits the supply of the consumable material or the insertion of the container device; a server apparatus configured to perform authentication for the container device based on the code; and a control unit configured to set, when the authentication is successful, setting data related to the container device received from the server apparatus in the image-forming apparatus.

### CROSS-REFERENCE TO RELATED APPLICATIONS

This application is a Continuation of International Patent Application No. PCT/JP2022/040368, Oct. 28, 2022, which claims the benefit of Japanese Patent Application No. 2022-007273, filed Jan. 20, 2022, both of which are hereby incorporated by reference herein in their entirety.

### BACKGROUND OF THE INVENTION

### Field of the Invention

The present invention relates to an image-forming system, a method, an image-forming apparatus, and a server apparatus.

### Background Art

An image-forming apparatus such as a copying machine, a printer, or a facsimile receiver forms an image on a recording medium by using consumable materials such as a developing agent like toner or ink and a photosensitive drum. When such a consumable material is exhausted or its remaining life ends, a user can continuously use the image-forming apparatus by replacing a cartridge or replenishing the image-forming apparatus with the consumable material from an external device. As compared with a widely-used detachable cartridge type, a replenishment type in which a device such as a replenishment pack is connected to the image-forming apparatus only at the time of replenishment is advantageous because of a low cost and a low environmental load. For example, PTL 1 proposes a mechanism for connecting a cylindrical container device that contains toner to a printer and replenishing the printer with the toner from the container device.

There is known an image-forming apparatus that performs advanced control based on information read out from a memory which is mounted in the above-described device such as a cartridge or replenishment pack. For example, PTL 2 discloses a technology in which data indicating a remaining amount of toner in a toner cartridge is stored in a memory of the cartridge and a user is prompted to order a cartridge in a timely manner when the data indicates a decrease in the remaining amount of toner. PTL 3 discloses a technology in which a printer reads out a random number value from a memory of a cartridge inserted into the printer and enables toner to be supplied from the cartridge when authentication based on the random number value is successful in a server apparatus. The printer described in PTL 1 also performs authentication based on authentication data read out from the memory of the container device, but the authentication is only local authentication by a single printer. PTL 4 discloses a technology in which history information of image-forming operations is stored in a memory of a cartridge inserted into a printer and a condition of an image-forming process is variably controlled based on the history information.

### CITATION LIST

### Patent Literature

PTL 1: International Publication No. 2020/046338
PTL 2: Japanese Patent Laid-Open No. 2015-090384
PTL 3: Japanese Patent Laid-Open No. 2021-030667
PTL 4: Japanese Patent Laid-Open No. 2002-091098

With the local authentication described in PTL 1, it is only possible to perform relatively simple device management based on information (for example, compatibility between the container device and the image-forming apparatus) known to the image-forming apparatus. On the other hand, if various kinds of information such as remaining amount data, a random number, and operation history described in PTLs 2 to 4 are stored in a memory of a container device, it will become possible to perform advanced control, but the cost of the device increases, which leads to an increase in a running cost borne by the user. The running cost can be minimized if no memory is mounted in the device and functions such as authentication or operation condition control are omitted. However, in this case, an image may not be formed under a condition suitable for the container device or the supplied consumable material, resulting in disadvantages for the user, such as a deterioration in image quality.

The technology according to the present disclosure aims at eliminating or mitigating at least one of the above-described inconveniences.

### SUMMARY OF THE INVENTION

According to an aspect, there is provided an image-forming system including: an image-forming apparatus present in a user environment and configured to form an image on a recording medium using a consumable material in a container device; an inhibiting mechanism disposed in at least one of the container device and the image-forming apparatus and capable of inhibiting supply of the consumable material from the container device to the image-forming apparatus or insertion of the container device into the image-forming apparatus; an obtainment unit configured to obtain a code unique to the container device in a state in which the inhibiting mechanism inhibits the supply of the consumable material or the insertion of the container device; a server apparatus present in a remote environment and configured to perform authentication for the container device based on the code obtained by the obtainment unit; and a first control unit present in the user environment and configured to set, in a case where the authentication performed by the server apparatus is successful, setting data related to the container device received from the server apparatus in the image-forming apparatus. There is also provided a corresponding method, an image-forming apparatus and a server apparatus.

Further features of the present invention will become apparent from the following description of exemplary embodiments with reference to the attached drawings.

### BRIEF DESCRIPTION OF THE DRAWINGS

FIG. 1 is a schematic view showing an example of a configuration of an image-forming system according to an embodiment.

FIG. 2A is a first schematic perspective view showing an example of the outer appearance of an image-forming apparatus according to a first configuration example.

FIG. 2B is a second schematic perspective view showing an example of the outer appearance of the image-forming apparatus according to the first configuration example.

FIG. 3 is a schematic cross-sectional view showing an example of the internal physical configuration of the image-forming apparatus according to the first configuration example.

FIG. 4 is a schematic perspective view for explaining an example of a configuration of a replenishment path according to the first configuration example.

FIG. 5 is a schematic cross-sectional view for explaining an example of a configuration of a preserving unit and its periphery according to the first configuration example.

FIG. 6A is a first schematic perspective view for explaining an example of the schematic configuration of a replenishment pack according to the first configuration example.

FIG. 6B is a second schematic perspective view for explaining an example of the schematic configuration of the replenishment pack according to the first configuration example.

FIG. 7A is a first explanatory view for explaining opening and closing of a discharge tray according to the first configuration example.

FIG. 7B is a second explanatory view for explaining opening and closing of the discharge tray according to the first configuration example.

FIG. 8 is an explanatory view showing a state in which the replenishment pack is connected to a toner receiving unit.

FIG. 9A is a first explanatory view for explaining an example of an inhibiting mechanism for locking the actuation of an opening and closing mechanism.

FIG. 9B is a second explanatory view for explaining an example of the inhibiting mechanism for locking the actuation of the opening and closing mechanism.

FIG. 10 is a schematic perspective view showing an example of the outer appearance of the image-forming apparatus according to a second configuration example.

FIG. 11 is a schematic perspective view showing a state in which a front cover of the image-forming apparatus shown in FIG. 10 is open.

FIG. 12 is a schematic cross-sectional view for explaining an example of the operation of the inhibiting mechanism of the image-forming apparatus according to the second configuration example.

FIG. 13 is a block diagram showing an example of a configuration of a management server according to an embodiment.

FIG. 14A is a table showing an example of a configuration of a setting management table that holds setting data.

FIG. 14B is a table showing another example of a configuration of the setting management table that holds setting data.

FIG. 15A is a table showing still another example of a configuration of the setting management table that holds setting data.

FIG. 15B is a table showing still another example of a configuration of the setting management table that holds setting data.

FIG. 16 is an explanatory view for explaining an example of update of a database at the time of apparatus registration.

FIG. 17 is an explanatory view for explaining an example of update of a database at the time of device delivery.

FIG. 18 is a block diagram showing an example of a configuration of a user terminal according to an embodiment.

FIG. 19 is a block diagram showing an example of the functional configuration of the image-forming apparatus according to an embodiment.

FIG. 20 is a sequence chart showing an example of a flow of schematic processing related to apparatus registration.

FIG. 21 is a sequence chart showing some examples of flows of schematic processing related to provision of a container device to a user.

FIG. 22 is a sequence chart showing an example of a flow of schematic processing in a case where the container device is used based on pre-use authentication.

FIG. 23 is a flowchart illustrating an example of a flow of authentication processing executed by the management server.

FIG. 24A is the first half of a flowchart illustrating a first example of a flow of lock control processing executed by the image-forming apparatus.

FIG. 24B is the second half of the flowchart illustrating the first example of the flow of the lock control processing executed by the image-forming apparatus.

FIG. 25A is the first half of a flowchart illustrating a second example of a flow of the lock control processing executed by the image-forming apparatus.

FIG. 25B is the second half of the flowchart illustrating the second example of the flow of the lock control processing executed by the image-forming apparatus.

FIG. 26 is an explanatory view showing an example of a message that may be displayed on a screen in a case where the setting data is reflected on the image-forming apparatus.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### <1. Overview of System>

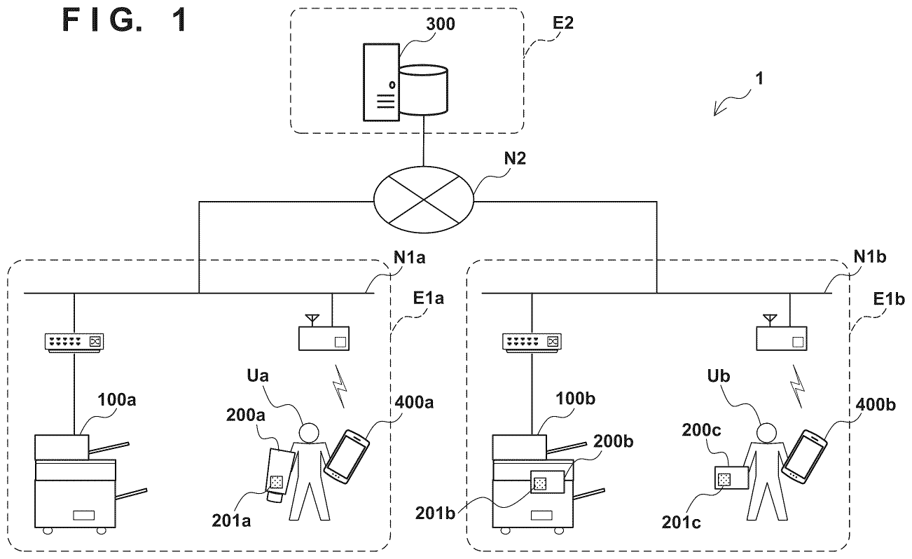

First, an overview of an image-forming system will be described with reference to FIG. 1. FIG. 1 is a schematic view showing an example of a configuration of an image-forming system 1 according to an embodiment. Referring to FIG. 1, the image-forming system 1 includes user environments E1a and E1b and a remote environment E2.

An image-forming apparatus 100a is installed in the user environment E1a. In the user environment E1a, a user Ua carries a user terminal 400a, and uses the image-forming apparatus 100a. The image-forming apparatus 100a and the user terminal 400a are connected to a local network N1a that may be, for example, a local area network (LAN). The local network N1a is connected to an external network N2 that may be, for example, the Internet or a virtual private network (VPN).

The image-forming apparatus 100a is a replenishment-type image-forming apparatus. That is, the image-forming apparatus 100a forms an image on a recording medium using toner that is replenished from a device temporarily connected to the apparatus and is preserved in the apparatus. FIG. 1 schematically shows a state in which the user Ua has a replenishment pack 200a. If toner in the image-forming apparatus 100a is exhausted, the user Ua connects the replenishment pack 200a to the image-forming apparatus 100a to replenish the image-forming apparatus 100a with toner from the replenishment pack 200a. The replenishment pack 200a is a kind of container device that contains a consumable material for image formation.

An image-forming apparatus 100b is installed in the user environment E1b. In the user environment E1b, a user Ub carries a user terminal 400b and uses the image-forming apparatus 100b. The image-forming apparatus 100b and the user terminal 400b are connected to a local network N1b that may be, for example, a LAN. The local network N1b is connected to the external network N2.

The image-forming apparatus 100b is an apparatus that forms an image on a recording medium using a consumable material contained in a detachable cartridge. In the example shown in FIG. 1, a cartridge 200b has already been inserted into the image-forming apparatus 100b. When the life of the cartridge 200b ends, the user Ub extracts the old cartridge 200b from the image-forming apparatus 100b, and inserts a new cartridge 200c into the image-forming apparatus 100b. Each of the cartridges 200b and 200c is a kind of container device that contains a consumable material for image formation.

The management server 300 is installed in the remote environment E2. The remote environment E2 is connected to the local networks N1a and N1b via the external network N2. Each of the local networks N1a and N1b and the external network N2 may include an arbitrary number of network apparatuses of any types such as a router, a switch, a gateway, a wireless access point, and a base station, for example.

Note that, in the following descriptions, when the image-forming apparatuses 100a and 100b do not need to be distinguished from each other, they will collectively be referred to as image-forming apparatuses 100 hereinafter by eliminating the alphabets at the ends of reference numerals. Furthermore, the replenishment pack 200a and the cartridges 200b and 200c will collectively be referred to as container devices 200 hereinafter. The same applies to the user terminals 400a and 400b (user terminals 400) and other components.

In this specification, an example in which the image-forming apparatuses 100a and 100b are printers (also referred to as laser printers) that form an image by an electrophotographic method will mainly be described. However, the technology according to the present disclosure is also applicable to any other kinds of printers such as an inkjet printer. In general, the technology according to the present disclosure can widely be applied to general image-forming apparatuses such as a copying machine, a printer, a facsimile receiver, and a multi-function peripheral regardless of whether these apparatuses are monochromatic or color apparatuses.

The management server 300 is a server apparatus for managing use of the container devices 200 at the image-forming apparatuses 100. The management server 300 may be an apparatus for centrally managing the use statuses of the image-forming apparatuses and container devices by a plurality of users. The management server 300 may be implemented as an application server, a database server, or a cloud server using, for example, a high-performance general-purpose computer.

Note that the functions of the management server 300 to be described in detail later may be provided by a single apparatus, or may be provided by a plurality of physically separate apparatuses in cooperation with each other. A part of a database, which is described as being held by the management server 300, may be held by an apparatus (for example, another database server) separate from the management server 300.

The user terminal 400 is a terminal apparatus that provides, to a user, a user interface for assisting device management functions of the management server 300. The user terminal 400 may be a general-purpose terminal apparatus such as a smartphone, a mobile phone, a personal computer (PC), or a personal digital assistant (PDA). The image-forming apparatus 100 may also provide a user interface to the user.

In the present embodiment, each container device 200 is provided with a unique code for uniquely identifying the container device 200. FIG. 1 shows a code 201a provided to the replenishment pack 200a, a code 201b provided to the cartridge 200b, and a code 201c provided to the cartridge 200c (these will be collectively referred to as codes 201 hereinafter). The code 201 may be referred to as, for example, a manufacturing number, a serial number, a device identifier, or the like. The code 201 is printed on the surface of each container device 200 or on the package of each container device 200 in a format that can be read by a human user or optically by a user terminal 400. The optically-readable format may include, for example, a format such as a one-dimensional barcode or a two-dimensional QR code®. The code 201 read by the user or by the user terminal 400 can be transmitted to the management server 300 and used for device management to be described below.

Note that FIG. 1 shows an example in which the image-forming system 1 includes the two user environments E1a and E1b and the one remote environment E2. However, the configuration of the image-forming system 1 is not limited to this example. For example, any numbers of user environments and remote environments may be present in the system, and any number of image-forming apparatuses may be installed in each user environment.

### 2. Configuration Example of Image-Forming Apparatus

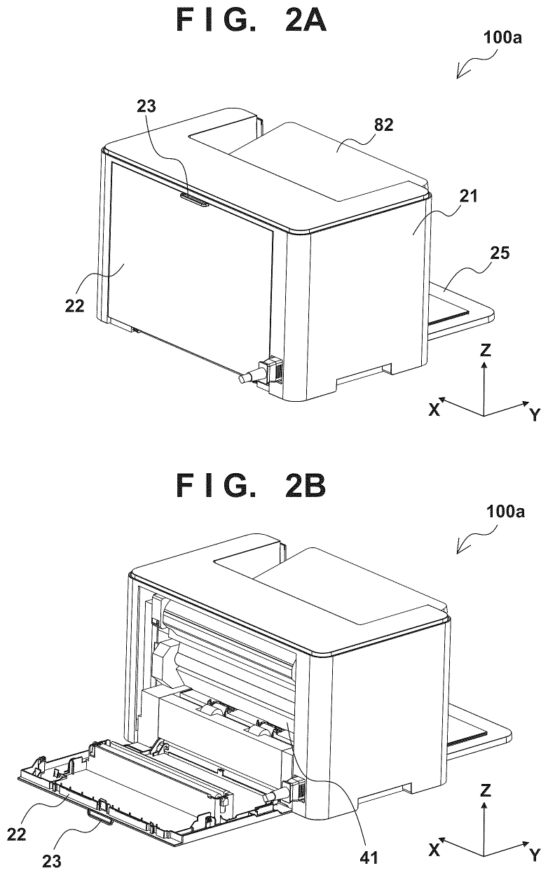

This section will describe two examples of a basic configuration of the image-forming apparatus 100 with reference to FIGS. 2A to 12. As a non-limiting example, the image-forming apparatus 100a according to a first configuration example is a replenishment-type monochromatic laser printer. The image-forming apparatus 100b according to a second configuration example is a cartridge-type color laser printer.

### 2-1. First Configuration Example

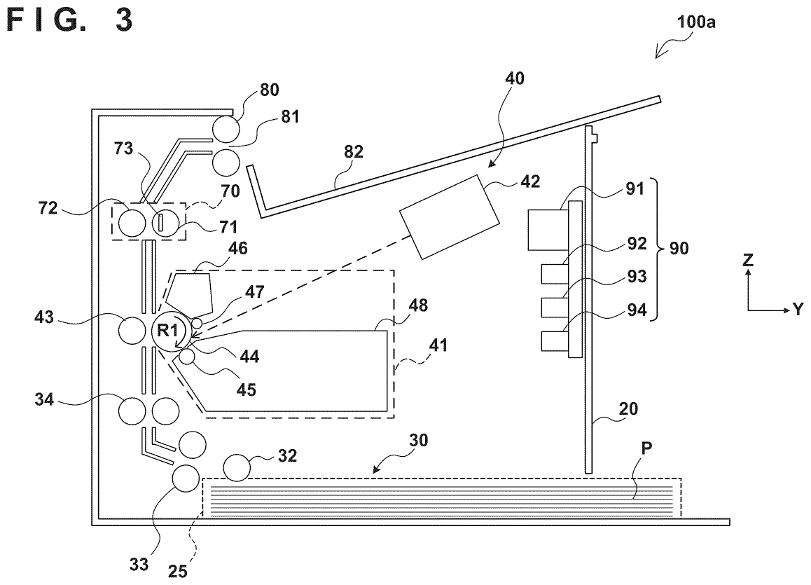

FIGS. 2A and 2B are schematic perspective views showing an example of the outer appearance of the image-forming apparatus 100a according to the first configuration example. FIG. 3 is a schematic cross-sectional view showing an example of the internal physical configuration of the image-forming apparatus 100a. The image-forming apparatus 100a forms an image on a recording medium based on input image data. Here, the recording medium may include various kinds of media of different materials, such as paper, a plastic film, an envelope, a sheet, and cloth.

In the following descriptions, a height direction of the image-forming apparatus 100a when the image-forming apparatus 100a is installed on a horizontal surface is set as a Z direction. A direction that is orthogonal to the Z direction and parallel to a rotational axis direction (main scanning direction) of a photosensitive drum 44 (to be described later) is set as an X direction. A direction orthogonal to the X direction and the Z direction is set as a Y direction.

### <2-1-1. Outer Appearance of Apparatus>

A housing of the image-forming apparatus 100a includes a front cover 20 (see FIG. 3), an exterior cover 21, a rear cover 22, and a discharge tray 82 (see FIG. 2A). A handle 23 is disposed on the rear cover 22. The front cover 20 is disposed on one of side surfaces of the image-forming apparatus 100a in a manner that it is openable and closable, and protects a processing circuit 90 (to be described later). The rear cover 22 is disposed on another side surface of the image-forming apparatus 100a in a manner that it is openable and closable. The user can open the rear cover 22 by grasping the handle 23 of the rear cover 22 to expose a part of a conveyance path through which a recording medium is conveyed, thereby performing a maintenance operation such as removal of jamming or replacement of a unit. FIG. 2A shows a state in which the rear cover 22 is closed, and FIG. 2B shows a state in which the rear cover 22 is open.

### <2-1-2. Internal Configuration of Apparatus>

Referring to FIG. 3, the image-forming apparatus 100a includes a sheet feed tray 25, a feed unit 30, an image-forming unit 40, a fixing unit 70, a discharge roller pair 80, and the processing circuit 90. The feed unit 30 feeds a recording medium toward the image-forming unit 40. The image-forming unit 40 forms an image on the recording medium using toner as a consumable material. Note that toner may be referred to as a developing agent, and an image formed using toner will sometime be referred to as a toner image or a developing agent image. The fixing unit 70 fixes the image formed by the image-forming unit 40 onto the recording medium. The discharge roller pair 80 discharges the recording medium processed by the fixing unit 70 to the discharge tray 82.

The image-forming unit 40 includes a process unit 41, a scanner unit 42, and a transfer roller 43. The process unit 41 includes the photosensitive drum 44, a developing roller 45, a cleaning unit 46, a charging roller 47, and a preserving unit 48. The process unit 41 may be fixed to the main body of the image-forming apparatus 100a or may be detachable from the main body.

The photosensitive drum 44 is an image carrier, and includes a photosensitive layer made of an organic photosensitive material on a drum-shaped substrate. The photosensitive drum 44 is rotationally driven in a direction R1 in the figure by a motor. The charging roller 47 is applied with a charging voltage by a high-voltage power supply, and pressed against the photosensitive drum 44 to uniformly charge the surface of the photosensitive drum 44. In accordance with the input image data, the scanner unit 42 irradiates the photosensitive drum 44 with a laser beam to expose the surface of the photosensitive drum 44 with light. This exposure forms an electrostatic latent image corresponding to the input image on the surface of the photosensitive drum 44. Note that the scanner unit 42 may irradiate the photosensitive drum 44 with light from an LED array instead of the laser beam.

The developing roller 45 is rotatably supported by the preserving unit 48. The preserving unit 48 preserves toner. Although not shown in FIG. 3, the preserving unit 48 may further include a supply roller that applies toner preserved in the preserving unit 48 to the surface of the developing roller 45. The developing roller 45 is applied with a developing voltage by the high-voltage power supply. When the toner carried on the developing roller 45 contacts the photosensitive drum 44, the toner transfers from the developing roller 45 to the drum surface according to the potential distribution on the surface of the photosensitive drum 44. This develops the electrostatic latent image to be a toner image.

The feed unit 30 includes a pickup roller 32, a separation roller pair 33, and a conveyance roller pair 34. The pickup roller 32 is located above the sheet feed tray 25, picks up one recording medium (to be simply referred to as a sheet hereinafter) from a bundle of recording media P stacked on the sheet feed tray 25, and feeds the recording medium to the separation roller pair 33. The separation roller pair 33 separates the sheet from the bundle and conveys the sheet toward the conveyance roller pair 34. The conveyance roller pair 34 conveys the sheet toward a transfer nip between the transfer roller 43 and the photosensitive drum 44. The transfer roller 43 is applied with a transfer voltage from the high-voltage power supply, and transfers the toner image developed on the surface of the photosensitive drum 44 to the sheet conveyed to the transfer nip.

The sheet onto which the toner image has been transferred is conveyed along the conveyance path and reaches the fixing unit 70. The fixing unit 70 includes a heating roller 71, a pressurizing roller 72, and a fixing heater 73. The heating roller 71 and the pressurizing roller 72 heat and pressurize the sheet as the sheet passes through the nip between the rollers. As a result, the toner particles melt and then fixes, thereby fixing the toner image to the sheet. The sheet that has passed through the fixing unit 70 is discharged from a discharge port 81 to the discharge tray 82 by the discharge roller pair 80. The cleaning unit 46 is disposed in the vicinity of the photosensitive drum 44. The cleaning unit 46 cleans the photosensitive drum 44 by scraping off toner remaining on the surface of the photosensitive drum 44.

The processing circuit 90 includes electronic components 91, 92, 93, and 94 disposed on a board. For example, the electronic component 91 may be a processor, the electronic component 92 may be a program memory, the electronic component 93 may be an input/output device, and the electronic component 94 may be a nonvolatile data memory. The input/output device may include a communication interface. When a job for instructing image formation is input to the image-forming apparatus 100a, an image-forming operation based on, for example, input image data received from an external computer is started. In the image-forming operation, as described above, the charging roller 47 performs a charging operation of charging the photosensitive drum 44. The scanner unit 42 performs an exposure operation of forming an electrostatic latent image on the photosensitive drum 44 by exposing the photosensitive drum 44 with light. The developing roller 45 performs a developing operation of supplying toner to the electrostatic latent image on the photosensitive drum 44 to obtain a toner image. The transfer roller 43 performs a transfer operation of transferring the toner image to the recording medium. The fixing unit 70 performs a fixing operation of fixing the toner image onto the recording medium by heating the toner image on the recording medium. The processing circuit 90 operates as a controller for controlling this image-forming operation.

### <2-1-3. Detailed Configuration of Preserving Unit>

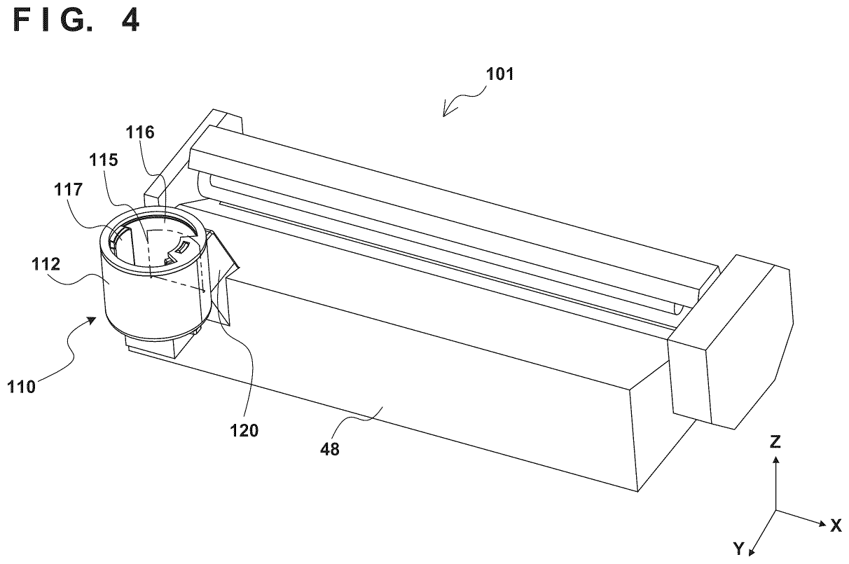

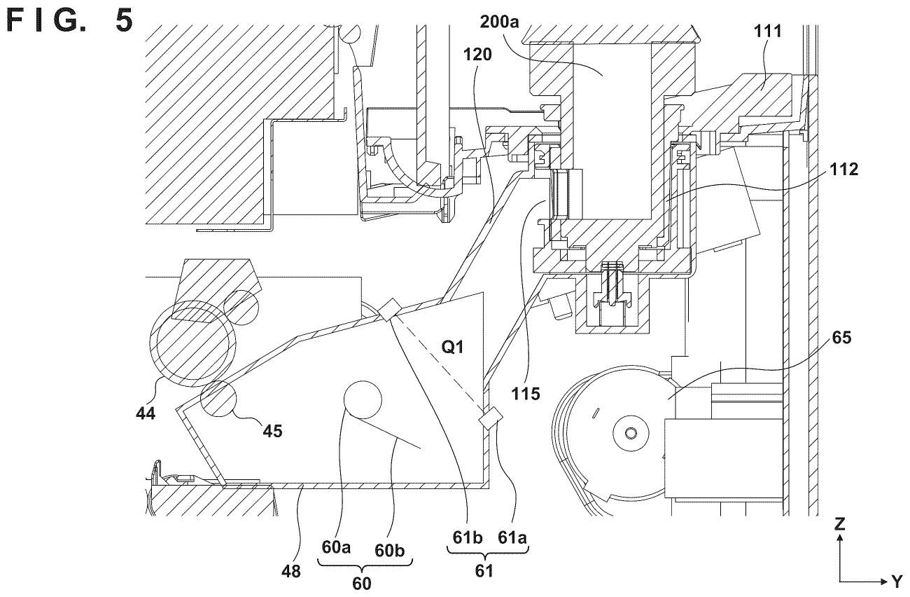

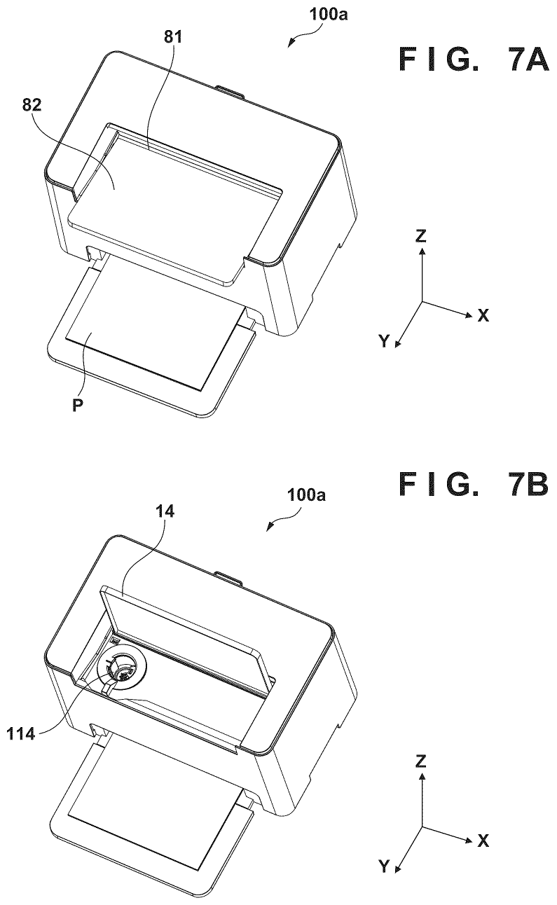

An example of a more detailed configuration related to the preserving unit 48 will be described next with reference to FIGS. 4 and 5. FIG. 4 is a schematic perspective view for explaining an example of a configuration of a replenishment path of the image-forming apparatus 100a. FIG. 5 is a schematic cross-sectional view for explaining an example of the configuration of the preserving unit 48 and its periphery. Referring to FIG. 4, the preserving unit 48 constitutes a part of a toner replenishing unit 101. The toner replenishing unit 101 includes the preserving unit 48 and a toner receiving unit 110. The toner receiving unit 110 includes a cylindrical member 112, a main body shutter 116, and a connecting member 120. Note that the toner receiving unit 110 further includes a ring member 111 which will be described in detail with reference to FIGS. 7A to 9B but the ring member 111 is not illustrated in FIG. 4 for the purpose of illustrating other constituent elements. An inner space of the cylindrical member 112 communicates with the preserving unit 48 via a side opening 115 and the connecting member 120 which is hollow. The main body shutter 116 serves as an opening and closing mechanism (to be described later) capable of opening and closing the replenishment path of toner from the replenishment pack 200a to the preserving unit 48. A protruding part 117 is formed on an inner-side surface of the main body shutter 116.

FIG. 5 shows a state in which the replenishment pack 200a is connected to the toner receiving unit 110, along with a cross-section of a configuration of the preserving unit 48 and its periphery. The replenishment pack 200a is temporarily connected to the image-forming apparatus 100a when supplying toner as a consumable material to the image-forming apparatus 100a. When the main body shutter 116 is opened, a replenishment path extending from the replenishment pack 200a to the preserving unit 48 through the connecting member 120 is opened. With the replenishment path open, the preserving unit 48 is replenished with toner discharged from the replenishment pack 200a through the replenishment path.

As shown in FIG. 5, an agitation member 60 including a shaft 60a disposed along the X direction and a blade 60b that pivots about the shaft 60a is provided inside the preserving unit 48. The blade 60b is driven by a motor 65 to pivot. With the pivot of the blade 60b, the toner in the preserving unit 48 is agitated and reaches the developing roller 45. Note that the agitation member 60 may include a spiral member instead of the blade 60b. The agitation member 60 may play a role of homogenizing the toner in the preserving unit 48 by scraping the toner from the developing roller 45 and circulating the toner in the preserving unit 48.

A remaining amount detection unit 61 is further disposed in the preserving unit 48. The remaining amount detection unit 61 is a sensor for detecting the remaining amount of toner in the preserving unit 48. The remaining amount detection unit 61 includes a light emitter 61a and a light receiver 61b. The light emitter 61a emits light that proceeds along an optical axis Q1 in the preserving unit 48. The light receiver 61b is disposed at a position facing the light emitter 61a, and receives the light emitted from the light emitter 61a. Note that when the light is guided by, for example, a light guide tube, the light receiver 61b need not necessarily be disposed at a position facing the light emitter 61a. The light emitter 61a may be, for example, a light-emitting element such as an LED, or may be a halogen lamp, a fluorescent lamp, or the like. The light receiver 61b may be, for example, a phototransistor, a photodiode, or an avalanche photodiode.

The light receiver 61b outputs a light detection signal having a signal level that depends on the amount of received light. For example, the light detection signal undergoes analog-to-digital conversion, and is then input to the processing circuit 90. The processing circuit 90 may estimate the remaining amount of toner based on, for example, the ratio of a time during which the light from the light emitter 61a is interrupted (by the toner) to a constant time window while the toner is agitated. Note that the remaining amount detection unit 61 is not limited to the configuration example described above, and the remaining amount of toner may be detected or estimated using any method. For example, the remaining amount of toner may be estimated by subtracting, from the total amount of toner at the time of previous toner replenishment, the total use amount thereafter. The processing circuit 90 may derive the use amount of toner based on a statistical value concerning the image-forming operation, such as the number of print media consumed by printing or a pixel count.

### <2-1-4. Configuration of Replenishment Pack>

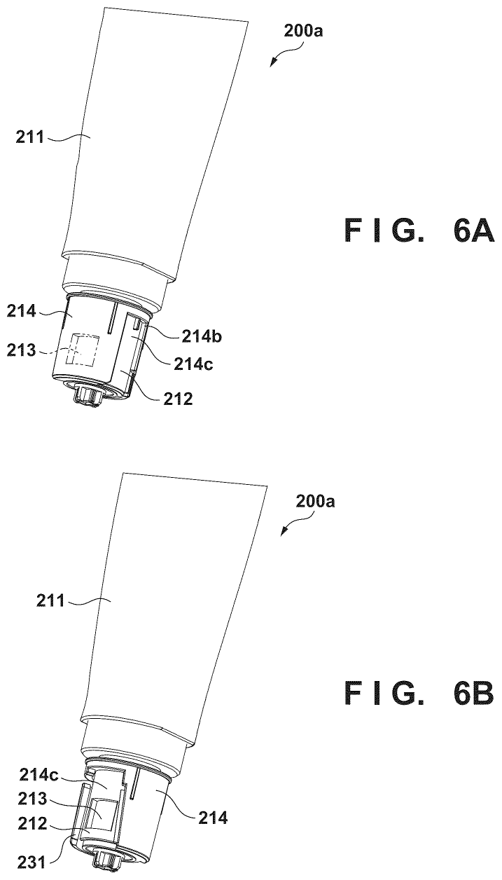

FIGS. 6A and 6B show an example of a schematic configuration of the replenishment pack 200a. In this configuration example, the replenishment pack 200a includes a containing part 211, a nozzle 212, and a pack shutter 214. The containing part 211 can be configured as, for example, a hollow tube or pouch for containing toner. The containing part 211 is filled with toner in advance. The containing part 211 may be, for example, a plastic bag that can easily deform. However, the containing part 211 is not limited to such examples, and may be made of any material such as a resin, paper, or vinyl, and may have any shape, such as a bottle, cylinder, or box.

The nozzle 212 is an interface portion with the toner receiving unit 110 of the image-forming apparatus 100a. The inside of the nozzle 212 communicates with the inside of the containing part 211. An opening 213 for discharging the toner to the outside is formed in a side surface of the nozzle 212. The opening 213 is normally closed by the pack shutter 214.

The pack shutter 214 is a cylindrical member concentric with the nozzle 212, and is disposed on an outer side of the nozzle 212 in a radial direction. The pack shutter 214 has an opening 214c. A part of an edge portion that forms the opening 214c constitutes a drive transmission surface 214b. When replenishing toner, the pack shutter 214 rotates relative to the nozzle 212 such that the opening 213 in the nozzle 212 is aligned with the opening 214c in the pack shutter 214, thereby making it possible to open a toner discharge path which has been closed by the pack shutter 214. As will be described below, the drive transmission surface 214b is a surface that receives a force which rotates the pack shutter 214. FIG. 6A shows a state in which the toner discharge path is closed, and FIG. 6B shows a state in which the toner discharge path is open. A sealing member 231 which normally shields the opening 213 in the nozzle 212 can further be disposed on the inner circumferential surface of the pack shutter 214. The sealing member 231 prevents toner from leaking from the replenishment pack 200a at the time other than the toner replenishment time.

### <2-1-5. Replenishment of Toner>

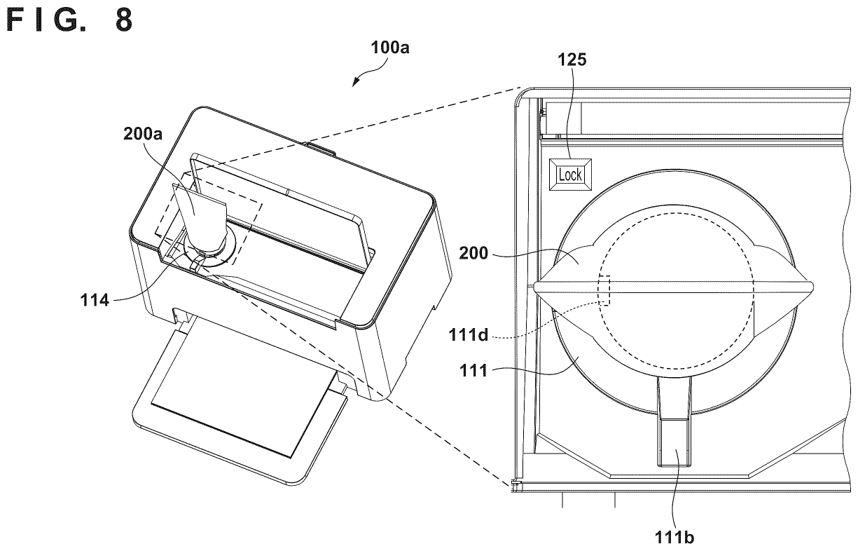

Next, a connection of the replenishment pack 200a to the toner receiving unit 110 will be described with reference to FIGS. 7A to 8. As shown in FIG. 7A, the discharge tray 82 is configured to be openable/closable about an opening and closing shaft disposed in the housing along the X direction. In the example shown in FIG. 7A, the discharge tray 82 is in a closed state, and a sheet discharged from the discharge port 81 is discharged onto the discharge tray 82 in this state. In the example shown in FIG. 7B, the discharge tray 82 is in an open state, and a replenishment port 114 of the toner receiving unit 110 is exposed in this state. That is, in this configuration example, the discharge tray 82 also functions as a shielding member that shields the replenishment port 114. A user can connect the replenishment pack 200a to the toner receiving unit 110 by lifting and opening the discharge tray 82, as shown in FIG. 7B, and inserting the nozzle 212 of the replenishment pack 200a into the exposed replenishment port 114, as shown on the left in FIG. 8.

The right side of FIG. 8 shows an enlarged view of a state in which the replenishment pack 200a is connected to the toner receiving unit 110. The ring member 111 surrounding the periphery of the replenishment port 114 is rotatably supported on the top surface of the cylindrical member 112. The ring member 111 includes a lever 111b that is gripped by the user, and a protruding part 111d indicated by a dotted line in FIG. 8. The protruding part 111d engages with the drive transmission surface 214b of the pack shutter 214 of the replenishment pack 200a inserted into the toner receiving unit 110. The drive transmission surface 214b also engages with the protruding part 117 (see FIG. 4) of the main body shutter 116. When the user operates the lever 111b to rotate the ring member 111 about a center axis, a force generated in the rotational direction is transmitted from the protruding part 111d to the drive transmission surface 214b of the pack shutter 214, and is further transmitted from the drive transmission surface 214b to the protruding part 117 of the main body shutter 116. As a result, the main body shutter 116 and the pack shutter 214 of the replenishment pack 200a can rotate in synchronism with the ring member 111, and for example, the toner replenishment path can be opened after rotation of 90°. When the replenishment path is opened, the toner contained in the containing part 211 of the replenishment pack 200a is injected into the toner receiving unit 110 from the opening 213 in the nozzle 212, and the preserving unit 48 is replenished with the toner through the connecting member 120. Note that the rotation of the ring member 111 can be restricted by a restricting member (not shown) so that the ring member 111 is not rotated exceeding a predetermined upper limit angle.

Although an example in which the toner replenishment path is opened by the force in the rotational direction generated when the user operates the lever 111b has been explained above, the replenishment path may alternatively be closed and opened regardless of user operations. As an example, the image-forming apparatus 100a may include a pack sensor that detects the connection of the replenishment pack 200a to the toner receiving unit 110, and a drive motor that generates a driving force for rotating the ring member 111. In this example, the processing circuit 90 may actuate the drive motor and rotate the ring member 111 with the rotational force of the drive motor to open the replenishment path under the condition that the pack sensor has detected the connection of the replenishment pack 200a to the toner receiving unit 110.

The opening and closing mechanism for opening and closing the replenishment path is not limited to the mechanism that uses the rotation of the shutter as described above. Instead of the rotating shutter, a shutter that is movable in a linear direction may be employed, or a mechanism different from a shutter, such as a valve, may be employed. It is sufficient for the opening and closing mechanism to be disposed in at least one of the container device like the replenishment pack 200a and the image-forming apparatus. That is, the replenishment path from the container device to the image-forming apparatus may always be open in one of the container device and the image-forming apparatus, and may be opened and closed only in the other. Alternatively, the replenishment path may be opened and closed in both the container device and the image-forming apparatus, as in the above-described example. In addition, a sensor for detecting an operation of the opening and closing mechanism by the user or detecting the state (the open state or the closed state) of the opening and closing mechanism may additionally be disposed.

In this configuration example, the above-described opening and closing mechanism is configured so that it is possible to inhibit the actuation of the opening and closing mechanism (and to deactivate the inhibition) by an inhibiting mechanism to be described in the next section. The inhibiting mechanism may be disposed in at least one of the container device and the image-forming apparatus, too. The replenishment port 114 of the image-forming apparatus 100a or the opening 213 of the replenishment pack 200a may be attached with a leak prevention member, such as a lid or a cap, to prevent the toner from leaking. Such a leak prevention member may be freely removable by the user.

### <2-1-6. Inhibition of Replenishment of Toner>

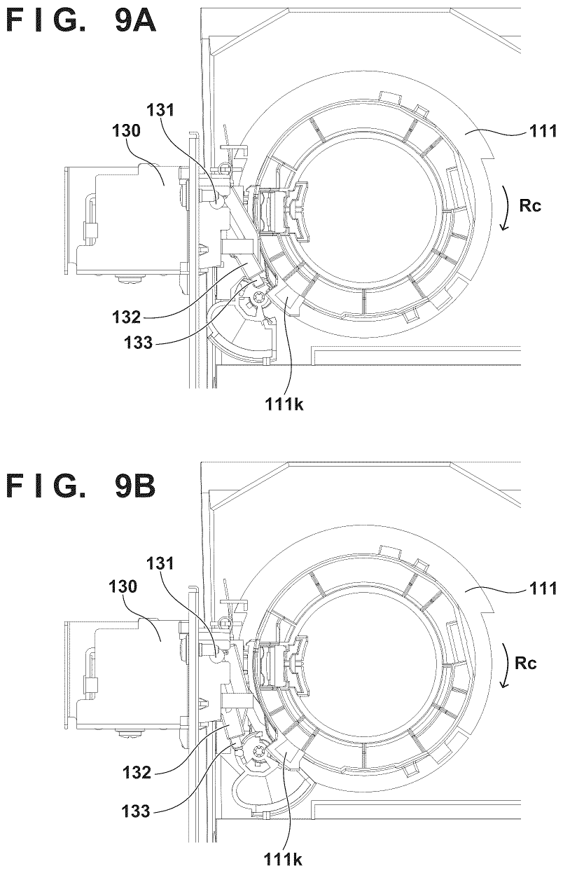

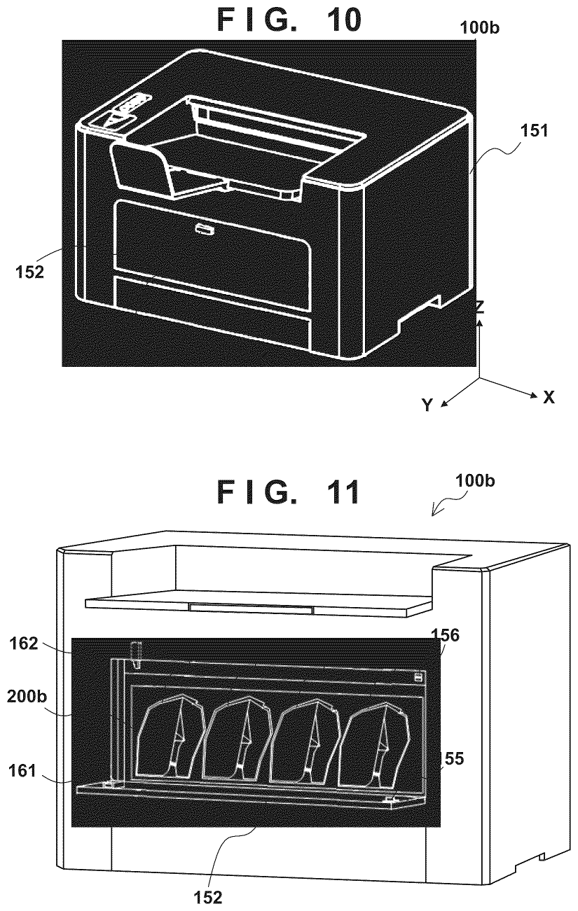

The ring member 111 of the image-forming apparatus 100a may normally be locked so as not to rotate even if the user applies a force thereto. FIGS. 9A and 9B are explanatory views for explaining an example of the inhibiting mechanism for locking the rotation of the ring member 111. FIGS. 9A and 9B show the toner receiving unit 110 when viewed from the inside of the apparatus (toward the Z direction) such that an example of the internal configuration of the toner receiving unit 110 can be understood in more detail. The toner receiving unit 110 includes, for example, a locking unit 130. The locking unit 130 includes a rod-shaped locking member 132 that is supported at one end by a shaft 131 and is pivotable about the shaft 131. The ring member 111 includes a protrusion 111k. The locking member 132 is normally biased, by the elastic force of a spring (not shown) within the locking unit 130, in a direction in which a tip 133 on the opposite side of the shaft 131 moves away from the locking unit 130, thereby locating the tip 133 on the rotational trajectory of the protrusion 111k of the ring member 111. Accordingly, even if the user attempts to rotate the ring member 111 in the clockwise direction in FIGS. 9A and 9B (a direction Rc in the figures), the tip 133 of the locking member 132 interferes with the protrusion 111k to inhibit the rotation of the ring member 111, and thus the opening and closing mechanism of the replenishment path is locked in the closed state (see FIG. 9A).

The locking unit 130 further includes, for example, a solenoid (not shown) for pivoting the locking member 132 in a direction opposite to that of the elastic force of the spring. The solenoid is temporarily energized during a period in which the replenishment of the toner from the replenishment pack 200a to the image-forming apparatus 100a is permitted, and the locking member 132 is pivoted by the attraction force thereof. When the solenoid is energized and the locking member 132 pivots, the tip 133 of the locking member 132 retracts from the rotational trajectory of the protrusion 111k of the ring member 111 (see FIG. 9B). As a result, the user can rotate the ring member 111 in the clockwise direction in FIG. 9B, that is, the opening and closing mechanism of the replenishment path is unlocked. The locking and unlocking of the opening and closing mechanism may be controlled by the processing circuit 90.

Note that in the first configuration example, the configuration of the inhibiting mechanism that locks and unlocks the opening and closing mechanism is not limited to the above-described example, and may be any mechanism such as a mechanical, electromagnetic, electrical, or software-based mechanism. For example, the locking member 132 may be driven by a motor or other types of actuators rather than a solenoid. In a case where an opening and closing mechanism actuated by computer control regardless of user operations is employed, the locking and unlocking of the opening and closing mechanism may be realized simply by program codes.

As shown on the right side of FIG. 8, an indicator 125 is disposed in the vicinity of the ring member 111. The indicator 125 indicates to the user whether the state of the above-described opening and closing mechanism is the locked state or the unlocked state. The indicator 125 may be constituted by, for example, a light-emitting diode (LED) disposed within the housing and a window that transmits light from the LED. When the indicator 125 indicates that the opening and closing mechanism is in the unlocked state, the user can rotate the ring member 111 to open the replenishment path.

### 2-2. Second Configuration Example

### <2-2-1. Outer Appearance of Apparatus>

FIG. 10 is a schematic perspective view showing an example of an outer appearance of the image-forming apparatus 100b according to the second configuration example. A housing of the image-forming apparatus 100b includes an exterior cover 151 and a front cover 152. A handle 153 is disposed on the front cover 152. For example, the lower side of the front cover 152 is connected at both ends thereof to the exterior cover 151 by hinges. The user can open the front cover 152 by grasping the handle 153 and pulling it forward. When the front cover 152 is opened, for example, an insertion path of the cartridge 200b to the image-forming apparatus 100b is opened. A rear cover (not shown) is disposed on the rear surface of the housing of the image-forming apparatus 100b on the opposite side of the front cover 152. The rear cover may also be openable/closable, and for example, the user can open the rear cover to expose the conveyance path within the housing so that jamming arising in the conveyance path can be removed.

FIG. 11 shows a state in which the front cover 152 of the image-forming apparatus 100b is open and the insertion path of the cartridge 200b is open. In this state in which the front cover 152 is open, the user can extract an old cartridge from the image-forming apparatus 100b and insert a new cartridge into the image-forming apparatus 100b. In the example shown in FIG. 11, the cartridge 200b includes process units 41Y, 41M, 41C, and 41K for respective four color components. That is, the cartridge 200b is a process cartridge. Each process unit of the process cartridge 200b can include, for example, one or more of an image carrier, a charging member, and a developing member in addition to a preserving unit containing toner.

A sensor flag 155 is disposed at one end of the upper side of the front cover 152. An opening and closing sensor 156 is disposed at a position, on the housing side, corresponding to the position of the sensor flag 155 in the state in which the front cover 152 is closed. As an example, the opening and closing sensor 156 may be a photointerrupter that senses light that can be shielded by the sensor flag 155, and outputs, to the processing circuit 90 of the image-forming apparatus 100b, a sensor signal indicating whether the front cover 152 is closed or open.

### <2-2-2. Inhibition of Insertion of Cartridge>

A pin receiving member 161 is disposed at the other end of the upper side of the front cover 152 of the image-forming apparatus 100b. A locking pin 162 is disposed at a position, on the housing side, corresponding to the position of the pin receiving member 161 in the state in which the front cover 152 is closed. The pin receiving member 161 and the locking pin 162 constitute a locking unit 160.

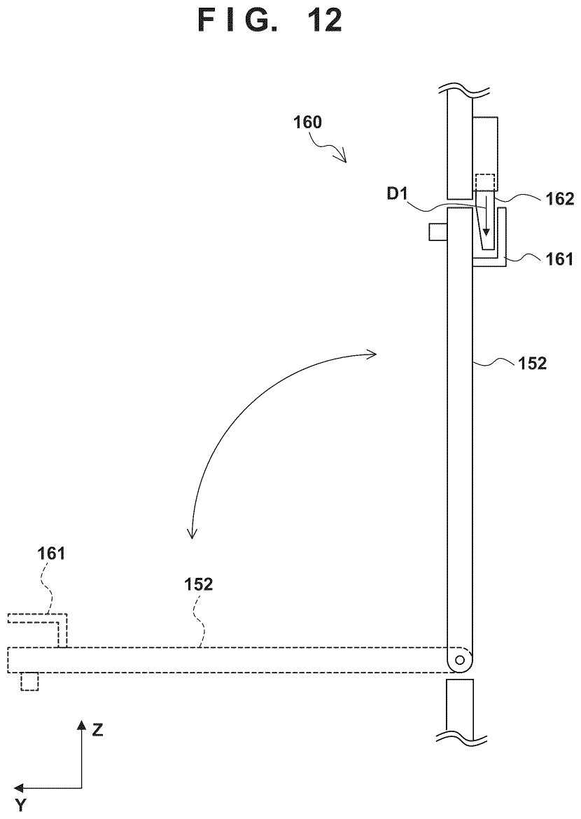

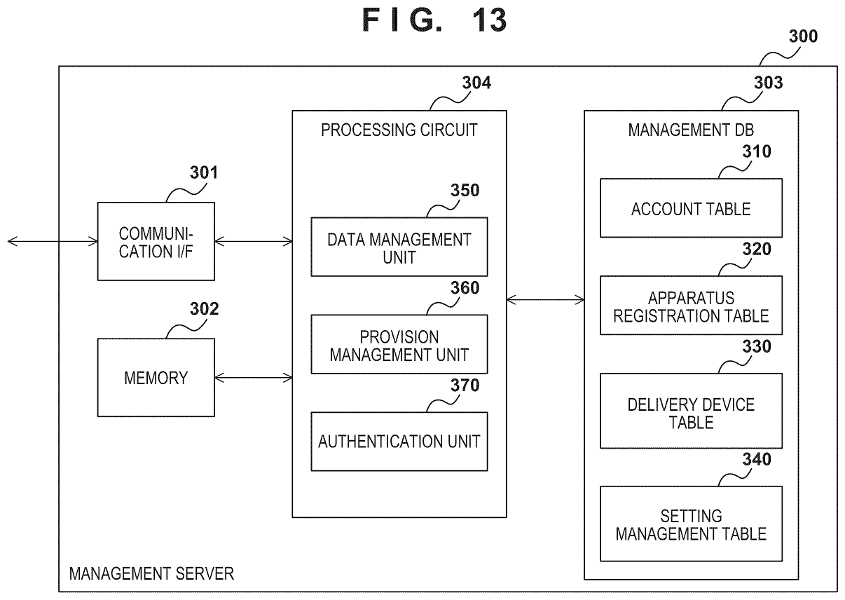

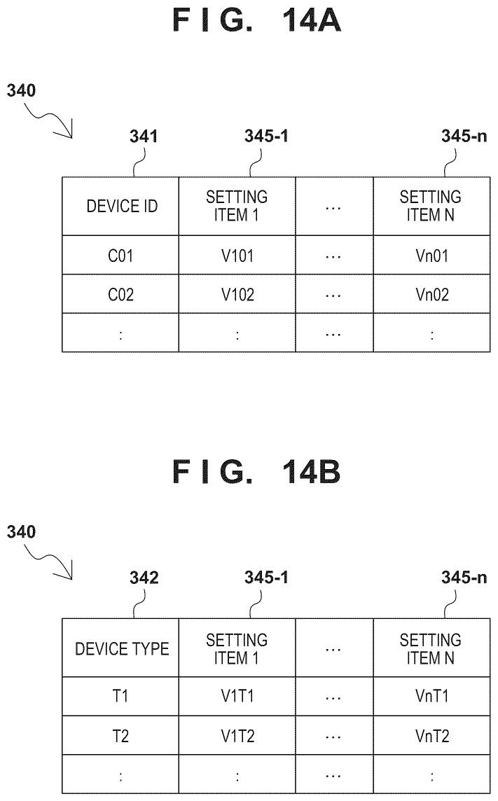

FIG. 12 is a schematic cross-sectional view for explaining an example of the operation of the locking unit 160 when viewed from a direction along the pivot axis of the front cover 152. In the example shown in FIG. 12, a solid line represents the front cover 152 in the closed state and a broken line represents the front cover 152 in the open state. The pin receiving member 161 that moves together with the front cover 152 forms, together with the inner surface of the front cover 152, a cavity having one opening end for receiving the locking pin 162. The locking pin 162 may be, for example, a rod-shaped member having a diameter slightly smaller than the inner diameter of the cavity formed by the pin receiving member 161. A side surface, on the front cover side, of the locking pin 162 is inclined so that the width, in the widthwise direction, of the cross-section of the locking pin 162 along a Y-Z plane gradually decreases toward the lower end.

The locking pin 162 normally projects in a direction D1 due to gravity or an elastic force of a spring (not shown). In the state in which the front cover 152 is closed, the locking pin 162 is inserted into the pin receiving member 161, and thus the locking pin 162 prevents the front cover 152 from pivoting even if the user pulls the front cover 152 in the Y direction. Therefore, the front cover 152 is inhibited from pivoting. To the contrary, if the user attempts to close the front cover 152 in the state in which the front cover 152 is open, the pin receiving member 161 abuts against the locking pin 162 to push up the inclined surface. This allows the pin receiving member 161 to pass through the position of the locking pin 162, and thus the user can close the front cover 152.

The locking unit 160 further includes, for example, a solenoid (not shown) for causing the locking pin 162 to retract in a direction opposite to the direction D1. The solenoid is temporarily energized during a period in which insertion of the cartridge (or replacement of the cartridge) is permitted. When the solenoid is energized and the locking pin 162 retracts, the locking pin 162 does not prevent the front cover 152 from pivoting, and thus the user can freely open the front cover 152 to insert the cartridge into the image-forming apparatus 100b.

Note that in the second configuration example, the configuration of the inhibiting mechanism for inhibiting the insertion of the cartridge is not limited to the above-described example. For example, instead of the mechanism for restricting the opening and closing of the cover, a mechanism of closing the insertion path of the cartridge may be employed as the inhibiting mechanism. For example, the insertion path of the cartridge may be closed by a movable shutter or stopper. Such an inhibiting mechanism may always allow a movement of a cartridge in the extraction direction while inhibiting a movement of a cartridge in the insertion direction. The movable member (for example, the above-described locking pin, shutter, or stopper) of the inhibiting mechanism may be driven by a motor or other types of actuators rather than a solenoid. In other words, the inhibiting mechanism may be any mechanism such as a mechanical, electromagnetic, electrical, or software-based mechanism. In a case where the cartridge is inserted and extracted by computer control regardless of user operations, the locking and unlocking of the inhibiting mechanism may be realized simply by program codes.

In the following descriptions, a state in which supply of the consumable material from the container device (the replenishment pack 200a in the first configuration example) to the image-forming apparatus or insertion of the container device (the cartridge 200b in the second configuration example) into the image-forming apparatus is possible will be referred to as the unlocked state. In addition, a state in which the supply of the consumable material from the container device to the image-forming apparatus or the insertion of the container device into the image-forming apparatus is inhibited and thus impossible will be referred to as the locked state.

### <2-2-3. Internal Configuration of Apparatus>

The image-forming function of the image-forming apparatus 100b may be configured similar to the above-described image-forming apparatus 100a except that the image-forming unit includes units for forming toner images of the respective four color components for color printing. The four color components may be, for example, yellow (Y), magenta (M), cyan (C), and black (K). The toner images of the four color components are not directly transferred from four photosensitive drums to a sheet but primarily transferred from the four photosensitive drums sequentially to an intermediate transfer belt to overlap each other and then transferred collectively from the intermediate transfer belt to a sheet.

The image-forming apparatus 100b also includes the processing circuit 90 that can include a processor, volatile and nonvolatile memories, an input/output device, and a communication interface. The processing circuit 90 operates as a controller for controlling an image-forming operation that can include one or more of the charging operation, the exposure operation, the developing operation, the transfer operation, and the fixing operation. The cartridge 200b inserted into the image-forming apparatus 100b may include a detection unit for detecting the remaining amount of toner, that is similar to the remaining amount detection unit 61 described with reference to FIG. 5. In addition to or instead of this, the detection unit of the cartridge 200b may detect a measure that affects a degree of consumption of a member, such as the sensitivity or rotation distance of the photosensitive drum or the driving time or voltage application time of another member. The processing circuit 90 of the image-forming apparatus 100b may estimate the remaining life level (to be also referred to as the “cartridge remaining amount”) for the cartridge 200b based on a value of the measure obtained from the detection unit.

### 3. Example of Configuration of Management Server

With a local authentication of a container device in each image-forming apparatus, it is only possible to perform relatively simple device management based on information known to the image-forming apparatus. If a memory capable of storing various kinds of information is mounted in the container device, more advanced control will be possible using information read out/written from/in the memory. However, mounting a memory means an increase in the cost of development and manufacturing of the container device, which leads to an increase in the running cost borne by a user. In the present embodiment, to implement advanced device management and control in consideration of a contract and other factors while avoiding necessity of mounting a memory in the container device, the management server 300 operating in the remote environment is introduced. The management server 300 manages or controls use of each container device 200 at an image-forming apparatus 100 in each user environment.

FIG. 13 is a block diagram showing an example of a configuration of the management server 300 according to the present embodiment. Referring to FIG. 13, the management server 300 includes a communication interface 301, a memory 302, a management database 303, and a processing circuit 304.

### (1) Communication Interface

The communication interface (I/F) 301 is an interface (also referred to as a communication unit) for the management server 300 to communicate with another apparatus. For example, the communication I/F 301 communicates with the image-forming apparatuses 100 and the user terminals 400 present in the user environments. The communication I/F 301 may be a wired communication interface or a wireless communication interface.

### (2) Memory

The memory 302 may include any type of storage medium including a semiconductor memory such as a read only memory (ROM) or random access memory (RAM), an optical disk, or a magnetic disk. The memory 302 may include a non-transitory computer-readable storage medium. The memory 302 stores one or more computer programs to be executed by the processing circuit 304 and various kinds of data.

### (3) Management Database

The management database (DB) 303 is constituted by tables for managing the use of the container devices 200 in one or more image-forming apparatuses 100 under the management of the image-forming system 1. More specifically, as shown in FIG. 13, the management DB 303 includes an account table 310, an apparatus registration table 320, a delivery device table 330, and a setting management table 340.

The account table 310 is a table that holds information concerning the accounts of users that use replenishment packs 200a provided by the image-forming system 1. The account table 310 can include, for example, one or more of the following information items:
“User ID”
“Password”
“Name”
“Email Address”
“Address”
“Contract Type”
“Payment Method”
“User ID” is identification information for uniquely identifying each of user accounts. “Password” is used in user authentication when a user logs in to the system. “Name” indicates the username of each account. For example, the username can be displayed on the screen after the login and used as a destination name at the time of delivery of a container device 200. “Address” can be used as a destination at the time of delivery of a container device 200. “Email Address” can be used when making various notifications to each user from the system via email. “Contract Type” indicates a type of a contract that each user has made with an operator that operates the image-forming system 1. A provision management unit 360 described below can determine when a container device 200 should be delivered to each user depending on the contract type of the user. “Payment Method” is information concerning a means by which the price of the container device 200 provided to each user is paid.

The apparatus registration table 320 is a table that holds information concerning the image-forming apparatuses registered in the image-forming system 1 as apparatuses of respective users. The apparatus registration table 320 can include, for example, one or more of the following information items:
“Owner”
“Apparatus ID”
“Apparatus Type”
“Registration Date”
“Status”
“Remaining Level”
“Owner” indicates an account of a user who owns or manages each image-forming apparatus by “User ID” registered in the account table 310. “Apparatus ID” is identification information for uniquely identifying each image-forming apparatus. A pair of “Owner” and “Apparatus ID” indicates an association between each user account and at least one image-forming apparatus registered as an apparatus of the user who has that account. Two or more image-forming apparatuses may be associated with one user account. “Apparatus Type” indicates a type of each image-forming apparatus. “Registration Date” indicates a date on which “Apparatus ID” of each image-forming apparatus was registered in the apparatus registration table 320. “Status” is status information concerning verification of whether each image-forming apparatus is actually installed in a user environment of “Owner”. When “Apparatus ID” is initially registered, “Status” indicates “Unverified”, and “Status” can be changed to “Verified” once the verification is complete. “Remaining Level” indicates the latest value of the remaining amount of a cartridge or toner estimated in each image-forming apparatus. For example, “Remaining Level” may be represented by a percentage. “Remaining Level” may be blank in a case where no cartridge has been inserted or a cartridge has been extracted for a cartridge-type image-forming apparatus 100b.

The delivery device table 330 is a table that holds information concerning container devices that have been shipped to respective users. The delivery device table 330 can include, for example, one or more of the following information items:
“Subscriber”
“Device ID”
“Type”
“Shipping Date”
“Status”
“Use Date”
“Subscriber” indicates an account of a user to which each cartridge is provided by “User ID” registered in the account table 310. “Device ID” is identification information for uniquely identifying each container device. A pair of “Subscriber” and “Device ID” indicates an association between each user account and at least one container device provided to the user who has that account. As each user repeatedly uses an image-forming apparatus 100, the number of container devices associated with one user account increases in the delivery device table 330. “Type” indicates a type of each container device or a type of a consumable material contained in each container device. “Shipping Date” indicates the date on which each container device was shipped to “Subscriber”. “Status” is status information concerning use of each container device. For example, “Status” indicates “Unused” at the time of shipment. Once each container device arrives in the user environment and is used or connected to the apparatus after completing authentication, “Status” can be changed to “Used” or “In Use”. “Use Date” indicates the date on which each container device was used. Note that instead of the apparatus registration table 320, the delivery device table 330 may include the data item “Remaining Level” described above.

The setting management table 340 is a table that holds setting data related to each container device and to be set in an image-forming apparatus when forming an image using the consumable material in the container device in the image-forming apparatus. As an example, the setting data is held in association with at least one of each individual container device and the type of each container device. As another example, the setting data may be held further in association with at least one of each individual image-forming apparatus and the type of each image-forming apparatus.

FIGS. 14A and 14B each show an example of a configuration of the setting management table 340. In the example shown in FIG. 14A, the setting management table 340 includes data items of a device ID 341 and first to n-th setting items 345-1 to 345-n. The device ID 341 indicates an individual container device associated with each record by “Device ID” registered in the delivery device table 330. The first to n-th setting items 345-1 to 345-n are data items for storing the values of n (n is an integer of 1 or more) operation parameters to be referred to in an image-forming operation. The operation parameters may include, for example, one or more of a charging voltage, a developing voltage, a transfer voltage, an exposure light amount, a fixing temperature, and a fixing pressure.

In the example shown in FIG. 14B, the setting management table 340 includes data items of a device type 342 and the first to n-th setting items 345-1 to 345-n. The device type 342 indicates the type of a container device associated with each record by “Type” registered in the delivery device table 330. Types of the container devices may be discriminated by any combination of attributes including, for example, a consumable material supply method, a storage amount, composition, a manufacturing lot, a manufacturer, and the manufacturing date.

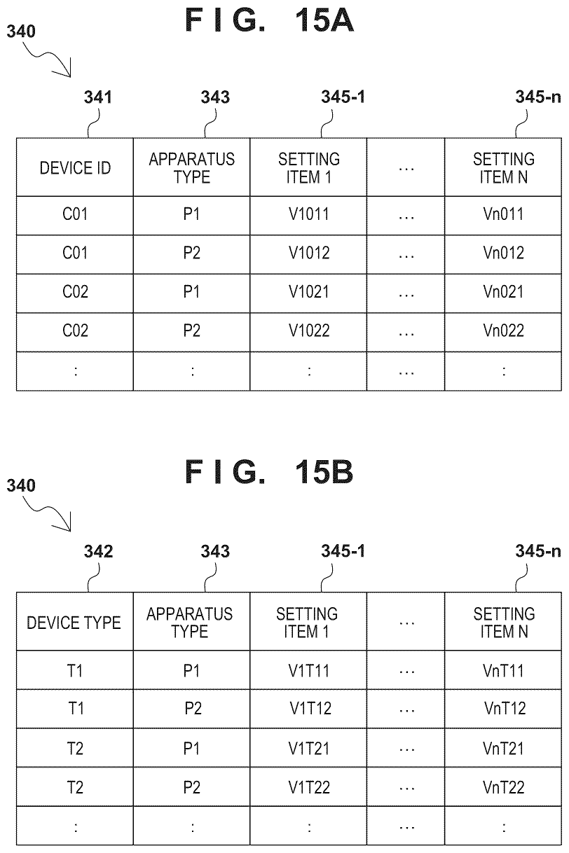

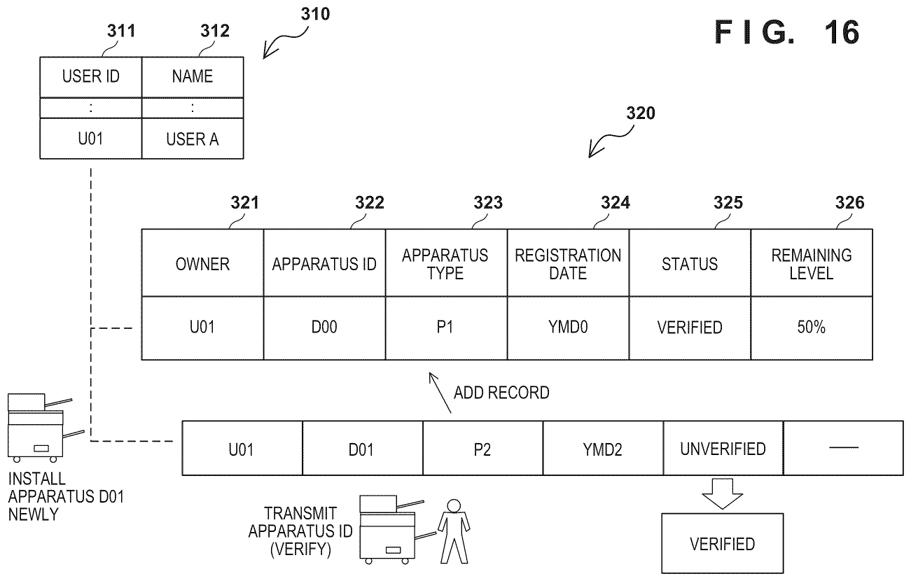

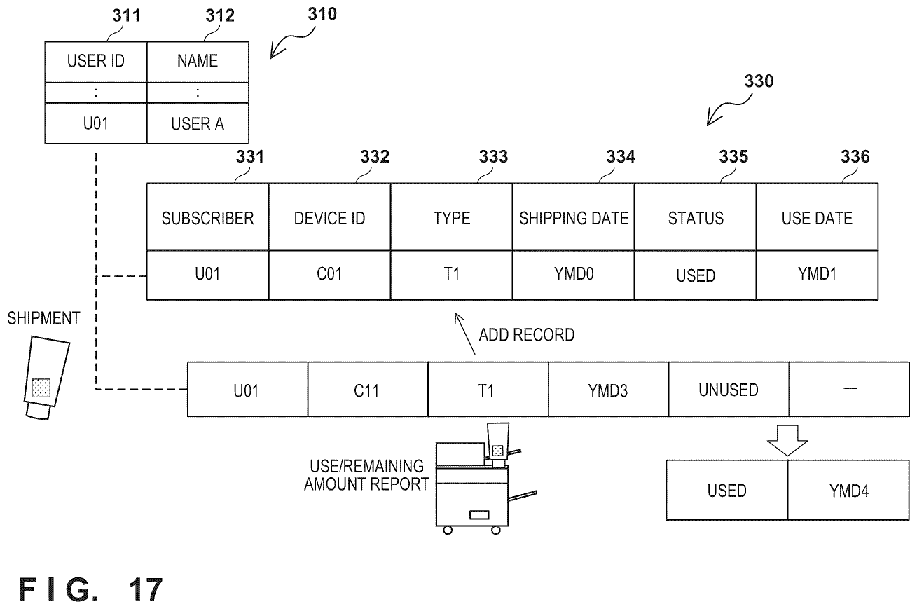

FIGS. 15A and 15B each show another example of a configuration of the setting management table 340. In the example shown in FIG. 15A, the setting management table 340 includes data items of the device ID 341, an apparatus type 343, and the first to n-th setting items 345-1 to 345-n. In this case, each record of the setting management table 340 is uniquely identified by a combination of the device ID 341 and the apparatus type 343. The apparatus type 343 indicates the type of an image-forming apparatus associated with each record by “Apparatus Type” registered in the apparatus registration table 320. Type of the image-forming apparatuses may be discriminated by, for example, any combination of attributes including, for example, a consumable material supply method, a model number, a manufacturer, and a manufacturing date.

In the example shown in FIG. 15B, the setting management table 340 includes data items of the device type 342, the apparatus type 343, and the first to n-th setting items 345-1 to 345-n. In this case, each record of the setting management table 340 is uniquely identified by a combination of the device type 342 and the apparatus type 343.

Although not shown, as another example of a table configuration, the setting management table 340 may include, as a data item, “Apparatus ID” indicating an individual image-forming apparatus associated with each record instead of the apparatus type 343 shown in FIG. 15A or 15B.

Regardless of which of the above-described configuration examples is employed, for example, the values of the respective operation parameters are determined based on a result of product testing so as to absorb variations of optimum values caused by changes in conditions (manufacturing conditions and environmental conditions) at the time of manufacturing container devices. Then, prior to provision of each container device to a user, a necessary record may be pre-registered in the setting management table 340.

### (4) Processing Circuit

The processing circuit 304 may include, for example, a central processing unit (CPU), and provides various functions of the management server 300 by executing computer programs stored in the memory 302. More specifically, as shown in FIG. 13, the processing circuit 304 may function as a data management unit 350, the provision management unit 360, and an authentication unit 370.

The data management unit 350 manages the registration and update of data in the management DB 303. The data management unit 350 may cause a user terminal 400 to display a screen for accepting an input of account information to be registered in the account table 310, receive the input account information via the communication I/F 301, and register the received account information in the account table 310. Similarly, the data management unit 350 may cause the user terminal 400 to display a screen for accepting an input of apparatus information for an image-forming apparatus held by each user, receive the input apparatus information via the communication I/F 301, and register the received apparatus information in the apparatus registration table 320. For example, these input screens may be provided in any format such as a web page, an input form, or an application screen. Typically, the input of the apparatus information may be accepted during a period in which the user has logged in to the system after user authentication using the user ID and password stored in the account table 310 succeeded.

For example, the data management unit 350 may perform, for the apparatus information registered in the apparatus registration table 320, simple verification of whether the apparatus is actually installed in the user environment of the corresponding user. When, for example, the user logs in to the system and inputs the apparatus information of the image-forming apparatus 100 to the input screen, the data management unit 350 presents, to the user, a message for prompting the user to perform a predetermined operation in the image-forming apparatus 100. The predetermined operation may be, for example, pressing a particular physical button of the image-forming apparatus 100 or touching a button on a graphical user interface (GUI). The message presented to the user may include contents that prompt the user to power on the image-forming apparatus 100 (in case the power of the image-forming apparatus 100 is OFF). When the user performs the prompted operation in the image-forming apparatus 100, the image-forming apparatus 100 transmits the apparatus ID for identifying the self-apparatus to the management server 300. The data management unit 350 stands by for reception of the apparatus ID from the image-forming apparatus 100 until a predetermined period elapses after the presentation of the above message. Then, if the same apparatus ID as the apparatus ID input by the user is received from the image-forming apparatus 100 prior to a timeout, the data management unit 350 determines that the image-forming apparatus 100 identified by that apparatus ID is actually installed in the user environment. The data management unit 350 sets the value of “Status” in the apparatus registration table 320 to “Unverified” for the apparatus before this verification is complete, and sets the value of “Status” in the apparatus registration table 320 to “Verified” for the apparatus after this verification is complete.

In the present embodiment, the data management unit 350 also manages update of the value of “Remaining Level” in the apparatus registration table 320. For example, the data management unit 350 receives, from the registered image-forming apparatus 100 via the communication I/F 301, remaining amount information concerning the remaining amount of an inserted cartridge or toner in the preserving unit 48 of this apparatus. The data management unit 350 then updates the value of “Remaining Level” as status information concerning the remaining amount based on the received remaining amount information.

The provision management unit 360 manages provision of container devices 200 to users of the image-forming system 1. For example, the provision management unit 360 monitors occurrence of a trigger event that triggers provision of a container device 200 to a user.

An example of the trigger event may be a purchase of a container device by a user. For example, an order for a container device is accepted through a website that sells products including replenishment packs and cartridges, the provision management unit 360 may start providing a container device to the user who has purchased it (that is, when an individual contract is established).

Another example of the trigger event is arrival of a provision timing based on a contract with a user. For example, it is assumed that a given user has made a regular purchase contract with an operator to periodically (for example, once a month or once every several months) purchase a certain number of container devices. The provision management unit 360 may start providing the container devices to the user when it is determined that the next provision timing for the container devices has arrived for the user.

Still another example of the trigger event may be detection of a decrease in the remaining level of a cartridge or toner in an image-forming apparatus 100 already registered in the apparatus registration table 320. For example, it is assumed that a given user has made an automatic purchase contract with an operator in which a new container device is automatically provided when the remaining level decreases with respect to the image-forming apparatus 100 owned by the user. In this case, the provision management unit 360 may monitor the value of “Remaining Level” in the apparatus registration table 320 for the registered image-forming apparatus 100 of the user, and start providing a container device to the user when the value is determined to be smaller than a predetermined threshold. Additionally or alternatively, the trigger event concerning the automatic purchase of container devices may be the number of operations of the registered image-forming apparatus 100 (for example, the number of times of execution of a job, or the total number of consumed recording media) reaching a threshold. Additionally or alternatively, the trigger event concerning the automatic purchase of container devices may be detection of use of a container device provided to the user in the past. For example, when the value of “Status” in the delivery device table 330 changes from “Unused” to “Used” or “In Use” regarding a container device provided to the user who has made the automatic purchase contract, the provision management unit 360 may start providing a new container device.

By providing a new cartridge 200 to a user periodically or automatically in response to detection of each of these trigger events, it is possible to reduce the possibility that the image-forming apparatus 100 becomes unusable when the remaining level becomes insufficient at an unexpected timing for the user.

Based on the contents of “Contract Type” in the account table 310, the provision management unit 360 can determine, for each user, which of the above-described trigger events is to be monitored. When it is determined for a given user that the trigger event has occurred, the provision management unit 360 assigns a new container device 200 to this user and transmits, to a delivery person, a message for instructing to deliver the assigned container device 200. In addition, the provision management unit 360 adds, to the delivery device table 330, a new record indicating the user ID of the delivery destination user and the device ID of the assigned container device 200, and registers the association between the user account and the container device 200 in the management DB 303. “Shipping Date” in the delivery device table 330 can be set to the date on which the container device 200 is shipped, and “Status” and “Use Date” can be set to “Unused” and blank, respectively, as initial values.

In addition to user authentication (for example, password authentication) when a user logs in to the system, the authentication unit 370 performs authentication for a container device 200 that is just to be used in an image-forming apparatus 100 (referred to as pre-use authentication hereinafter) to give permission to use it. This pre-use authentication can include determination of whether to permit the use of the container device 200 (for example, whether the container device 200 is provided to the user through a regular route). As described with reference to FIG. 1, in the present embodiment, a unique code 201 for uniquely identifying each container device 200 is provided to that container device 200. The code 201 is printed on, for example, each container device 200 or on the package thereof, in a format that can be read by a user or by a user terminal 400. The authentication unit 370 receives the code of the container device 200 to be used from a code obtainment means present in the user environment, and performs pre-use authentication based on the received code. Several examples of a method of obtaining the code of the container device 200 in the user environment will be given below.

As an example, the code 201 may be identical with the device ID of each container device 200. In this case, the authentication unit 370 can use the received code as is for pre-use authentication. As another example, the code 201 may be generated by encoding the device ID of each container device 200. In this case, the authentication unit 370 can use, for pre-use authentication, the device ID that is derived by decoding the code 201.

The pre-use authentication may include determination of whether the container device 200 identified based on the code 201 has correspondence with the user account of the login user. For example, the authentication unit 370 checks whether an association between the device ID based on the code 201 and the user ID of the login user has been registered in the delivery device table 330. If this association has been registered in the delivery device table 330, the authentication unit 370 may determine that the container device 200 to be used has correspondence with the user account of the user. By verifying the correspondence between the container device 200 and the user account in this manner, it is possible to prevent a container device 200 obtained without a contract from being used in an image-forming apparatus 100.

Additionally or alternatively, the pre-use authentication may include determination of whether the image-forming apparatus 100 (also referred to as a target apparatus hereinafter) in which the container device 200 is to be used has correspondence with the user account of the login user. For example, the authentication unit 370 presents, to the user who attempts to use the container device 200, a message for prompting the user to perform a predetermined operation in the target apparatus. In this case as well, the predetermined operation may be, for example, pressing a particular physical button of the image-forming apparatus 100 or touching a button on a GUI. When the user performs the prompted operation in the image-forming apparatus 100, the image-forming apparatus 100 transmits the apparatus ID for identifying the self-apparatus to the management server 300. The authentication unit 370 stands by for reception of the apparatus ID from the image-forming apparatus 100 until a predetermined period elapses after the presentation of the above message. Then, the authentication unit 370 checks whether an association between the apparatus ID received from the image-forming apparatus 100 prior to a timeout and the user ID of the login user has been registered in the apparatus registration table 320. If this association has been registered in the apparatus registration table 320, the authentication unit 370 may determine that the target apparatus has correspondence with the user account of the login user. By employing, as a condition for authentication success, the condition that the target apparatus has been registered as an apparatus of the user in this manner, it is possible to promote registration of apparatus information in the database. In addition, by receiving the apparatus ID from the image-forming apparatus 100, the management server 300 can reliably recognize the target apparatus, and can transmit a control command to the target apparatus thereafter.

In response to the aforementioned predetermined operation, the authentication unit 370 may receive the latest remaining amount information together with the apparatus ID from the image-forming apparatus 100. Then, in a case where the received remaining amount information indicates that there remains sufficient toner or cartridge life, the authentication unit 370 may reject replenishment of toner from a replenishment pack to the image-forming apparatus 100 or insertion of a cartridge to the image-forming apparatus 100. This makes it possible to prevent the image-forming apparatus 100 from being excessively replenished with toner or prevent the cartridge in use from being extracted and discarded even though the cartridge life is still sufficient.

Additionally or alternatively, the pre-use authentication may include determination, based on the value of “Status” in the delivery device table 330, of whether the container device 200 identified based on the code 201 is unused. For example, the authentication unit 370 may refer to the record of the device ID based on the code 201 in the delivery device table 330 and permit the container device 200 to be used in a case where the value of “Status” is “Unused”. On the other hand, the authentication unit 370 may reject the container device 200 to be used in a case where the value of “Status” in the referred record is not “Unused”.

Additionally or alternatively, the pre-use authentication may include determination of whether the container device 200 identified based on the code 201 is a genuine product suitable for the target apparatus. Here, the genuine product refers to a product that meets the terms of the contract that the user has made with the operator. For example, in a case where the user has made a regular purchase contract (also referred to as a subscription contract), products provided to the user based on the regular purchase contract can be genuine products. To determine whether a product is genuine, the apparatus registration table 320 may include a model number of each image-forming apparatus as an additional data item, and the delivery device table 330 may include a model number of each device as an additional data item. In addition, the management DB 303 may include an additional table indicating model numbers of one or more container devices suitable for a model number of each image-forming apparatus. In this case, the authentication unit 370 may permit the container device 200 to be used only when the respective model numbers of the target apparatus and the container device 200 are determined to be compatible with each other.

As described above, at least one of the image-forming apparatus 100 and the container device 200 includes an inhibiting mechanism capable of inhibiting the supply of the consumable material from the container device 200 to the image-forming apparatus 100 or the insertion of the container device 200 into the image-forming apparatus 100. In principle, this inhibiting mechanism is maintained in a locked state unless the above-described pre-use authentication is successful. When the pre-use authentication is successful, the authentication unit 370 causes the image-forming apparatus 100 to switch the state of the inhibiting mechanism from the locked state to the unlocked state by transmitting a result indicating authentication success or an unlock command to the image-forming apparatus 100 via the communication I/F 301. The unlock command to the image-forming apparatus 100 may be transmitted directly from the management server 300 to the image-forming apparatus 100. Alternatively, the user terminal 400 that has received the result indicating authentication success from the management server 300 may transmit the unlock command to the image-forming apparatus 100. When the pre-use authentication fails due to any of the above-described conditions not being met, the authentication unit 370 transmits a result indicating an authentication failure to the image-forming apparatus 100 or the user terminal 400 via the communication I/F 301. The authentication unit 370 may cause a screen of any of the apparatuses to display a message indicating the cause of the authentication failure (for example, an unauthorized device, an unregistered apparatus, or a used device).

When the inhibiting mechanism is unlocked based on the authentication result, and the image-forming apparatus 100 is replenished with toner from the replenishment pack 200a or the cartridge 200b is inserted, the remaining amount of toner or cartridge indicated by the remaining amount information of the image-forming apparatus 100 increases. As will be described below, the image-forming apparatus 100 detects an increase in the remaining amount of toner or cartridge, and transmits the remaining amount information to the management server 300. The data management unit 350 receives this remaining amount information via the communication I/F 301 and updates the value of “Remaining Level” in the apparatus registration table 320. In a case where the received remaining amount information indicates an increase in the remaining amount, the data management unit 350 also changes “Status” of a corresponding record in the delivery device table 330 to “Used” or “In Use”. As a result, it will be possible not to permit the container device 200 to be reused based on the status information when an attempt is made to reuse the same container device 200 at a later time. In addition, in response to detection of the use of the container device 200, the provision management unit 360 can assign a new container device 200 to the user.

In response to the success of the pre-use authentication for the container device 200 or the above-described change in the status of the container device 200, the authentication unit 370 reads out the setting data registered in the setting management table 340 in association with the container device 200. Then, the authentication unit 370 provides the readout setting data to the image-forming apparatus 100. The setting data may be transmitted to the image-forming apparatus 100 together with the above-described unlock command or may be transmitted to the image-forming apparatus 100 separately from the unlock command.

As an example, the setting data provided to the image-forming apparatus 100 may be data associated with the device ID of the container device 200 for which the authentication is successful and indicating operation parameter values optimum for the individual container device 200. As another example, the setting data provided to the image-forming apparatus 100 may be data associated with the device type of the container device 200 for which the authentication is successful and indicating operation parameter values suitable for the type of the container device 200. By providing such setting data to the target apparatus to set for an image-forming operation, the target apparatus can form a high-quality image without being influenced by a change in conditions at the time of manufacturing the container device to be used.

As still another example, the setting data provided to the image-forming apparatus 100 may be data indicating operation parameter values associated with a combination of the apparatus ID of the target apparatus and the device ID or device type of the container device 200 for which the authentication is successful. As still another example, the setting data provided to the image-forming apparatus 100 may be data indicating operation parameter values associated with a combination of the apparatus type of the target apparatus and the device ID or device type of the container device 200 for which the authentication is successful. By providing such setting data to the target apparatus to set for an image-forming operation, the target apparatus can form a higher-quality image in accordance with the operation parameter values also suitable for an operation characteristic unique to the target apparatus.

Update of the contents of the management DB 303 according to typical processing flows will be described below with reference to FIGS. 16 and 17. FIG. 16 shows an example of update of the apparatus registration table 320 at the time of apparatus registration. The account table 310 including User ID 311 and Name 312 as data items is shown in the upper part of FIG. 16. Other data items in the account table 310 are not illustrated in FIG. 16. The apparatus registration table 320 including Owner 321, Apparatus ID 322, Apparatus Type 323, Registration Date 324, Status 325, and Remaining Level 326 as data items is shown in the middle part of FIG. 16. In the example shown in FIG. 16, the account of a user (referred to as a user U01 hereinafter) identified by a user ID “U01” has already been registered in the account table 310. In addition, an image-forming apparatus identified by an apparatus ID “D00” has already been registered in the apparatus registration table 320 as an apparatus of the user U01.

The user U01 newly installs an image-forming apparatus (referred to as an apparatus D01 hereinafter) identified by an apparatus ID “D01” in the user environment. When the user U01 inputs the apparatus information of the apparatus D01 through the input screen provided by the management server 300, the management server 300 adds a record for the apparatus information of the apparatus D01 to the apparatus registration table 320. In the added record, Owner 321 is “U01”, Apparatus ID 322 is “D01”, Apparatus Type 323 is “P2”, Registration Date 324 is the date of registration, Status 325 is “Unverified”, and Remaining Level 326 is blank.

Furthermore, the user U01 performs an operation for apparatus registration in the newly installed apparatus D01 in accordance with, for example, a message displayed on the screen. The apparatus D01 stores, in advance, the apparatus ID “D01” of the self-apparatus, and transmits the apparatus information including the apparatus ID to the management server 300 in response to the operation by the user. If the apparatus ID received in this manner matches the apparatus ID input by the user U01, the data management unit 350 changes the value of Status 325 of the record added to the apparatus registration table 320 from “Unverified” to “Verified”, as shown in the lower part of FIG. 16.

FIG. 17 shows an example of update of the delivery device table 330 at the time of device delivery. The upper part of FIG. 17 shows the contents of the account table 310 that is similar to that shown in FIG. 16. The delivery device table 330 including Subscriber 331, Device ID 332, Type 333, Shipping Date 334, Status 335, and Use Date 336 as data items is shown in the middle part of FIG. 17. In the example shown in FIG. 17, the container device identified by a device ID “C01” has already been provided to the user U01, and the container device has already been authenticated and used.

In response to detection of one of the above-described trigger events, the provision management unit 360 newly assigns a container device (referred to as a device C11 hereinafter) identified by a device ID “C11” to the user U01. In addition, the provision management unit 360 adds a record for managing the status of the assigned device C11 to the delivery device table 330. In the added record, Subscriber 331 is “U01”, Device ID 332 is “C11”, Type 333 is “T1”, Shipping date 334 is the date of shipment, Status 335 is “Unused”, and Use Date 336 is blank.

When the authentication by the authentication unit 370 is successful and the use of the device C11 is started, the target apparatus reports an increase in the remaining amount to the management server 300. Based on this report, the data management unit 350 changes the value of Status 335 of the record added to the delivery device table 330 from “Unused” to “Used”, and adds the date of the report on an increase in the remaining amount to Use Date 336.

### 4. Example of Configuration of User Terminal

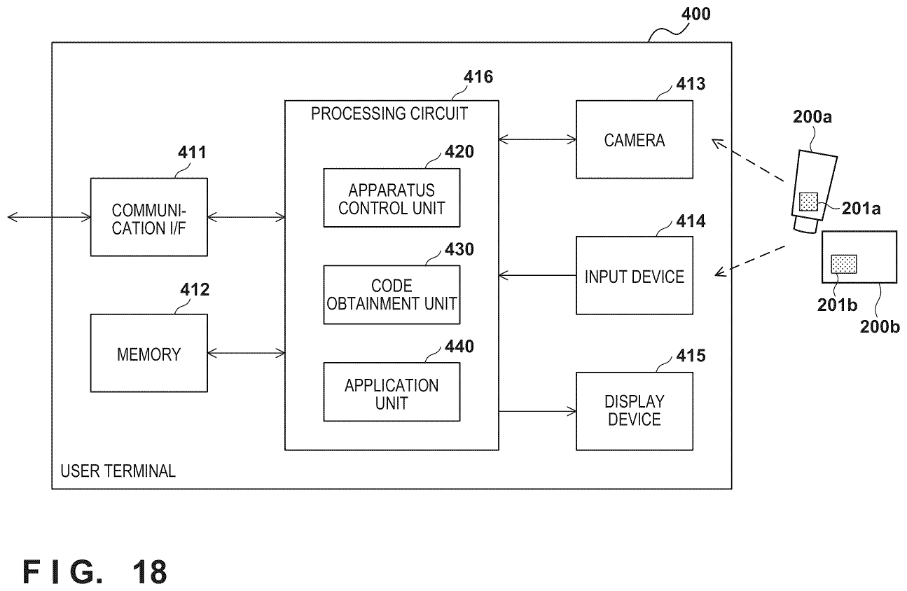

FIG. 18 is a block diagram showing an example of a configuration of the user terminal 400 according to the present embodiment. Referring to FIG. 18, the user terminal 400 includes a communication I/F 411, a memory 412, a camera 413, an input device 414, a display device 415, and a processing circuit 416.

The communication I/F 411 is an interface for the user terminal 400 to communicate with another apparatus. For example, the communication I/F 411 communicates with an image-forming apparatus 100 present in the user environment and the management server 300 present in the remote environment. The communication I/F 411 may be a wired communication interface or a wireless communication interface. If the communication I/F 411 is a wireless communication interface, the communication I/F 411 may be, for example, a WLAN interface that communicates with a WLAN access point or a cellular communication interface that communicates with a cellular base station. Note that although FIG. 18 shows only the single communication I/F 411, the user terminal 400 may include a plurality of different communication modules for communicating with the image-forming apparatus 100 and the management server 300, respectively. The communication between the user terminal 400 and the image-forming apparatus 100 may also be performed using a communication protocol for connecting peripheral devices, such as Bluetooth® or universal serial bus (USB).

The memory 412 may include any type of storage medium including a semiconductor memory such as a ROM or a RAM, an optical disk, or a magnetic disk. The memory 412 may include a non-transitory computer-readable storage medium. The memory 412 stores one or more computer programs to be executed by the processing circuit 416 and various kinds of data.

The camera 413 is a module capable of capturing an image or video of a subject. In a practical example described below, the camera 413 is used to optically read a code 201 unique to a container device 200.

The input device 414 is used as a user interface for accepting a user operation and information input. The input device 414 may include one or more of, for example, a touch sensor, a keypad, a keyboard, a pointing device, and a microphone. In a practical example described below, a code 201 unique to a container device 200 is input by a user through the input device 414.

The display device 415 is used to display an image and information. The display device 415 may be constituted by, for example, a liquid crystal display (LCD) or organic light-emitting diode (OLED).

The processing circuit 416 may include, for example, a CPU, and provides various functions of the user terminal 400 by executing computer programs stored in the memory 412. More specifically, as shown in FIG. 18, the processing circuit 416 may function as an apparatus control unit 420, a code obtainment unit 430, and an application unit 440. Note that only the functions related to management of use of container devices 200 in the image-forming apparatus 100 will mainly be described in this specification, but the processing circuit 416 may also provide the user with many other functions that the a terminal generally has.

The apparatus control unit 420 controls image formation and other operations performed by the image-forming apparatus 100. The apparatus control unit 420 may include driver software for the image-forming apparatus 100. For example, the apparatus control unit 420 detects one or more apparatuses that can be used by the user terminal 400 present in the user environment, and presents a list of the detected apparatuses to the user on the screen of the display device 415. The apparatus control unit 420 may obtain the status of each apparatus (for example, power on/off, remaining amount information, and the like) and present the obtained status to the user. When the user selects an image-forming apparatus 100 and instructs to execute printing, the apparatus control unit 420 transmits a print job including image data of an image to be printed to the image-forming apparatus 100, thereby causing the image-forming apparatus 100 to print the image.

The code obtainment unit 430 obtains a code 201 unique to a container device 200 to be used by the user, in a state in which the inhibiting mechanism of the image-forming apparatus 100 inhibits supply of a consumable material from the container device 200 or insertion of the container device 200. As an example, in a case where the code 201 is an optically-readable code printed on the container device 200 or a package thereof (for example, a wrapper, a piece of paper included therein, or the like), the code obtainment unit 430 may optically read the code 201 using the camera 413. As another example, in a case where the code 201 is a code that can be read by a human (for example, visually), the code obtainment unit 430 may allow the user to input the code 201 using the input device 414 and obtain the input code 201.

The application unit 440 may be an application for device management, that operates in cooperation with the management server 300. The application unit 440 may be a web browser. For example, the application unit 440 causes the display device 415 to display an account information input screen in a case where a user account is newly registered, and in a case where a user account is changed. When the account information is input to the account information input screen, the application unit 440 transmits the accepted account information to the management server 300 via the communication I/F 411. The application unit 440 also causes the display device 415 to display an apparatus information input screen in a case where the image-forming apparatus 100 is installed in the user environment. When the apparatus information is input to the apparatus information input screen, the application unit 440 transmits the accepted apparatus information to the management server 300 via the communication I/F 411.

The application unit 440 may also provide, to a user who wishes to use a container device 200 in the image-forming apparatus 100, a user interface for requesting the management server 300 to execute the pre-use authentication. For example, when the user operates a button for making an authentication request, the application unit 440 activates the code obtainment unit 430 to obtain the code unique to the container device 200, and transmits the obtained code 201 to the management server 300 via the communication I/F 411. The application unit 440 may transmit the code 201 to the management server 300 as part of a request for permission to use the device. Alternatively, the application unit 440 may transmit the code 201 to the management server 300 as part of a request to unlock the inhibiting mechanism.

In a practical example, the application unit 440 may transmit a transmission request to the image-forming apparatus 100, requesting to transmit, to the management server 300, the apparatus ID required for the pre-use authentication by the management server 300. In another practical example, the application unit 440 may cause the display device 415 to display a message for prompting the user to perform an operation for transmitting the apparatus ID in the image-forming apparatus 100.

When the pre-use authentication is performed by the management server 300 based on the code 201 unique to the container device 200, the application unit 440 receives the result of the pre-use authentication from the management server 300. If the authentication result indicates that the pre-use authentication is successful, the application unit 440 may cause the apparatus control unit 420 to transmit an unlock command to the image-forming apparatus 100 to unlock the inhibiting mechanism. Note that in a case where the command is transmitted directly from the management server 300 to the image-forming apparatus 100, the user terminal 400 does not need to transmit the command to the image-forming apparatus 100.

The application unit 440 causes the display device 415 to display the result of the pre-use authentication received from the management server 300. As an example, in a case where the container device 200 is a replenishment pack, when the result of the pre-use authentication indicates that the authentication is successful, the user connects the replenishment pack to the image-forming apparatus 100, and operates the opening and closing mechanism that has been keeping the replenishment path closed. Then, the replenishment path is opened and it becomes possible to replenish the image-forming apparatus 100 with toner from the replenishment pack. In this case, the inhibiting mechanism of the image-forming apparatus 100 is in the unlocked state, and thus the operation of opening the replenishment path by the user is not inhibited. As another example, in a case where the container device 200 is a cartridge, when the result of the pre-use authentication indicates that the authentication is successful, the user inserts a new cartridge into the image-forming apparatus 100 (for example, after opening the front cover and extracting the old cartridge, as needed). In this case, since the inhibiting mechanism of the image-forming apparatus 100 is in the unlocked state, a cartridge replacement operation is not inhibited. In a case where the result of the pre-use authentication indicates that the authentication has failed, the user reattempts the pre-use authentication after taking appropriate measures, or gives up using the container device 200 for a while, depending on the cause of the failure that may be displayed on the screen. In this case, the inhibiting mechanism is maintained in the locked state by the image-forming apparatus 100.

### 5. Example of Functional Configuration of Image-Forming Apparatus

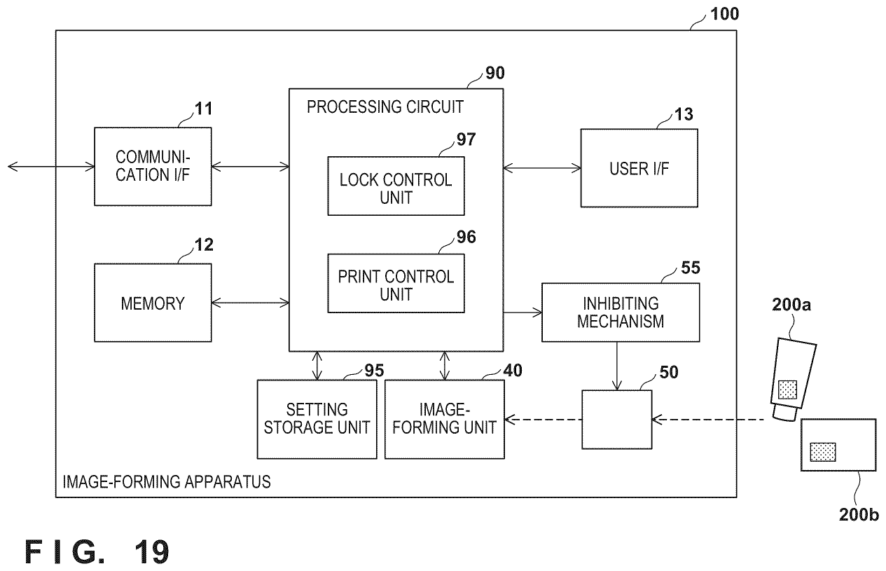

FIG. 19 is a block diagram showing an example of a functional configuration of the image-forming apparatus 100 according to the present embodiment. Referring to FIG. 19, the image-forming apparatus 100 includes a communication I/F 11, a memory 12, a user I/F 13, the image-forming unit 40, an inhibiting target 50, an inhibiting mechanism 55, the processing circuit 90, and a setting storage unit 95. From a functional perspective, the processing circuit 90 may mainly function as a print control unit 96 and a lock control unit 97.

The communication I/F 11 is an interface for the image-forming apparatus 100 to communicate with another apparatus. For example, the communication I/F 11 communicates with the user terminal 400 present in the user environment and the management server 300 present in the remote environment. The communication I/F 11 may be a wired communication interface or a wireless communication interface. If the communication I/F 11 is a wireless communication interface, the communication I/F 11 may be, for example, a WLAN interface or a cellular communication interface. Note that although only the single communication I/F 11 is shown in FIG. 19, the image-forming apparatus 100 may include a plurality of different communication modules for communicating with the user terminal 400 and the management server 300, respectively.

The memory 12 may include any type of storage medium including a semiconductor memory such as a ROM or a RAM, an optical disk, or a magnetic disk. The memory 12 may include a non-transitory computer-readable storage medium. The memory 12 stores one or more computer programs to be executed by the processing circuit 90 and various kinds of data. The memory 12 stores, in advance, for example, the apparatus ID (also referred to as apparatus identification information) for uniquely identifying the image-forming apparatus 100.

The user I/F 13 may include an input device for accepting a user operation and information input, and a display device for displaying an image and information. For example, the user I/F 13 may include one or more of a touch panel, a keypad, buttons, switches, a microphone, and a loudspeaker. The user I/F 13 may be treated as an operation terminal integrated into the image-forming apparatus 100. In a practical example, the user I/F 13 may be used to accept an input of a code 201 unique to a container device 200.

In a case where the image-forming apparatus 100 is a replenishment-type apparatus, the inhibiting target 50 may be, for example, the opening and closing mechanism (including, for example, the ring member 111 and the main body shutter 116) or a part of it described in connection with the image-forming apparatus 100a. In this case, the inhibiting mechanism 55 corresponds to the above-described locking unit 130, and can inhibit supply of toner from a replenishment pack to the image-forming apparatus 100 (for example, the inhibiting mechanism 55 can inhibit the operation or automatic actuation of the opening and closing mechanism). In a case where the image-forming apparatus 100 is a cartridge-type apparatus, the inhibiting target 50 may be, for example, the insertion path of the cartridge described in connection with the image-forming apparatus 100b. In this case, the inhibiting mechanism 55 corresponds to the above-described locking unit 160, and can inhibit insertion of a cartridge into the image-forming apparatus 100 (for example, the inhibiting mechanism 55 can close the insertion path of the cartridge or restrict the movement of the cartridge along the insertion path). Extraction of the cartridge from the image-forming apparatus 100 may or may not be inhibited.

The image-forming unit 40 forms an image on a recording medium by consuming consumable material in a container device 200 under the control of the print control unit 96. The image-forming unit 40 is typically constituted by a plurality of members that operate in cooperation with each other. The respective members of the image-forming unit 40 operate in accordance with corresponding operation parameter values included in the setting data stored in the setting storage unit 95.

The setting storage unit 95 includes a storage region for storing setting data received from the management server 300 and associated with the container device 200 which the image-forming apparatus 100 is permitted to use. For example, characteristics (for example, resistance values) of the consumable material in container devices 200 are not always uniform over a plurality of devices and there are individual differences. Such individual differences may be inspected through testing before shipment of the devices, and numerically expressed. The setting data here is determined in advance so as to, for example, absorb the influence from the individual differences on image-forming operations, and held in a database accessible by the management server 300. The image-forming apparatus 100 may receive such setting data from the management server 300. The setting data may be a set of operation parameter values such as the charging voltage of the charging roller 47, the developing voltage of the developing roller 45, the transfer voltage of the transfer roller 43, the exposure light amount of the scanner unit 42, and the fixing temperature and fixing pressure of the fixing unit 70.

Note that at the time of shipment of an image-forming apparatus 100, the image-forming apparatus 100 may preserve a developing agent usable by the image-forming unit 40 or may include an inserted usable cartridge. In this case, the setting storage unit 95 may store initial setting data related to the usable consumable material at the time of shipment. The initial setting data may be read out from the setting storage unit 95 and used by the image-forming unit 40 in an image-forming operation before pre-use authentication succeeds.

For example, in the setting storage unit 95, the above-described initial setting data may be overwritten in the same storage region by setting data received from the management server 300 after the pre-use authentication succeeds. In this case, it is sufficient for the setting storage unit 95 to have only a storage region with such a size that a single set of setting data can be stored, thereby saving a memory resource. As the same operation parameters are consistently read out from the same addresses of the memory in image-forming operations, it becomes easier to implement the image-forming operations.

In an alteration example, the setting storage unit 95 may include a first storage region in which setting data received from the management server 300 is stored and a second storage region in which default setting data that is usable before the pre-use authentication succeeds. By holding, in this way, the default setting data separately from the setting data that can be used when authentication is successful, it is possible to avoid a situation in which image formation cannot be performed although there is a usable consumable material, under an irregular condition such as a loss of a code or a communication failure. In this alteration example, it may be made possible to unlock the inhibiting mechanism by exceptionally omitting the pre-use authentication when a special user operation (for example, in the image-forming apparatus 100 or the user terminal 400) is detected. Furthermore, under a condition that a special user operation is performed, it may be made possible to use a container device not supporting the authentication based on a code unique to the device. The special user operation may be, for example, a button operation in a predetermined pattern or input of a passcode. In this case, however, setting data suitable for the consumable material or the container device in use is not provided, and thus a high-quality image is not always formed.

The print control unit 96 controls settings and operations for image formation by the image-forming unit 40. For example, when the pre-use authentication performed by the management server 300 is successful, the print control unit 96 receives the setting data related to the container device 200 permitted to be used from the management server 300 via the communication I/F 11, and stores the received setting data in the setting storage unit 95. Then, upon accepting a print job, the print control unit 96 controls the image-forming unit 40 to form, on a recording medium, an image based on input image data designated in the print job. At this time, the print control unit 96 reads out the above-described setting data stored in the setting storage unit 95, and uses the readout setting data to control the image-forming operation of the image-forming unit 40. This setting data indicates operation parameter values determined such that operation conditions suitable for an individual container device or consumable material are used, and may be updated every time a new container device is used. Therefore, even when the developing agent is re-replenished or the cartridge is replaced, the image-forming apparatus 100 can continuously use its optimum operation conditions for forming a high-quality image.

Note that the setting data stored in the setting storage unit 95 may indicate not the absolute values of the respective operation parameters but difference values with respect to predetermined reference values (for example, initial values). In this case, to control the image-forming unit 40, the print control unit 96 uses a value obtained by adding the difference value read out from the setting storage unit 95 to the reference value of each operation parameter. Additionally or alternatively, the setting data may indicate a coefficient value by which the reference value of each operation parameter is to be multiplied. In this case, to control the image-forming unit 40, the print control unit 96 uses a value obtained by multiplying the reference value of each operation parameter by the coefficient value read out from the setting storage unit 95.

The lock control unit 97 controls switching between the locked state and the unlocked state of the inhibiting mechanism 55. For example, when a predetermined input signal is detected, the lock control unit 97 transmits the apparatus ID stored in the memory 12 to the management server 300. The apparatus ID transmitted to the management server 300 may be used to verify whether the image-forming apparatus 100 identified by an apparatus ID designated by a user for apparatus registration is actually installed in the user environment of the user. Furthermore, the apparatus ID transmitted to the management server 300 may be used to execute the pre-use authentication by the management server 300. The lock control unit 97 may transmit the latest remaining amount information to the management server 300 together with the apparatus ID.

In a practical example, the input signal that triggers transmission of the apparatus ID is a reception signal (for example, a transmission request for requesting transmission of the apparatus ID) received from the user terminal 400 via the communication I/F 11. In this case, in response to reception of the transmission request, the lock control unit 97 reads out the apparatus ID from the memory 12, and transmits the readout apparatus ID to the management server 300. In another practical example, the input signal that triggers transmission of the apparatus ID is a user input signal (for example, an operation signal indicating that a predetermined button has been operated) detected via the user I/F 13. In this case, in response to detection of the user input signal, the lock control unit 97 reads out the apparatus ID from the memory 12, and transmits the readout apparatus ID to the management server 300.

After transmitting the apparatus ID to the management server 300 for the pre-use authentication, the lock control unit 97 stands by for reception of an unlock command as a control signal based on the result of the pre-use authentication for a predetermined standby period. Then, when the lock control unit 97 receives an unlock command before the standby period expires, it causes the inhibiting mechanism 55 to transition from the locked state to the unlocked state (by, for example, energizing the solenoid as described above) in accordance with the unlock command. That is, when the pre-use authentication performed by the management server 300 is successful, the lock control unit 97 switches the inhibiting mechanism 55 to a state in which it is possible to supply the consumable material or to insert a container device 200.

If the standby period expires (that is, a timeout occurs) without receiving the unlock command, the lock control unit 97 ends the standby for the command. For example, the lock control unit 97 may stand by for the unlock command by temporarily opening a specific reception port of the communication I/F 11. By standing by for a control signal from the outside only for a limited period using, as a trigger, detection of a predetermined input signal in this way, it is possible to minimize the risk of an unauthorized operation of the image-forming apparatus 100 by a malicious third party. Furthermore, in a period other than the standby period, the image-forming apparatus 100 or the communication I/F 11 can be set in a sleep state, thereby reducing power consumption.

In a case where the unlock command is received before the standby period expires, the lock control unit 97 may keep the inhibiting mechanism 55 in the unlocked state for a predetermined unlocked period from when the command is received, and then cause the inhibiting mechanism 55 to transition back to the locked state after the unlocked period expires.

The print control unit 96 controls the remaining amount detection unit 61 to detect the remaining amount of toner or cartridge in the image-forming apparatus 100 when, for example, an image-forming operation is performed, replenishment of toner from a replenishment pack is performed, or a cartridge is inserted. The remaining amount detection unit 61 reports the detected remaining amount of toner or cartridge to the print control unit 96. The print control unit 96 reports remaining amount information indicating the thus detected remaining amount to the management server 300 via the communication I/F 11. Instead of being directly transmitted to the management server 300, the remaining amount report may be transmitted to the management server 300 via the user terminal 400.

By detecting an increase in the remaining amount of toner or cartridge based on the remaining amount information as described above, the management server 300 can ascertain that the container device 200 for which the pre-use authentication is successful has been used by the user. Note that, instead of the management server 300, the image-forming apparatus 100 or the user terminal 400 may determine the increase in the remaining amount and transmit, to the management server 300, a notification signal indicating that the container device 200 has been used.

### <6. Flow of Processing>

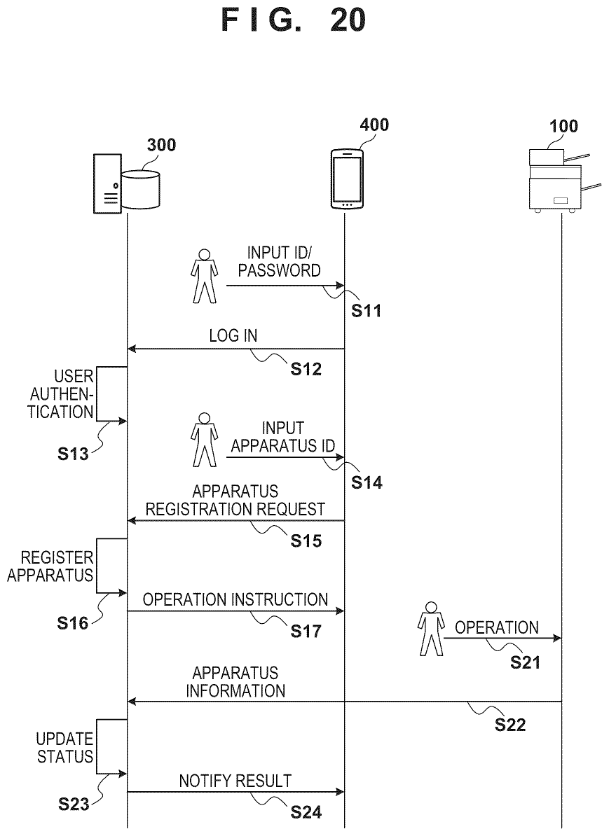

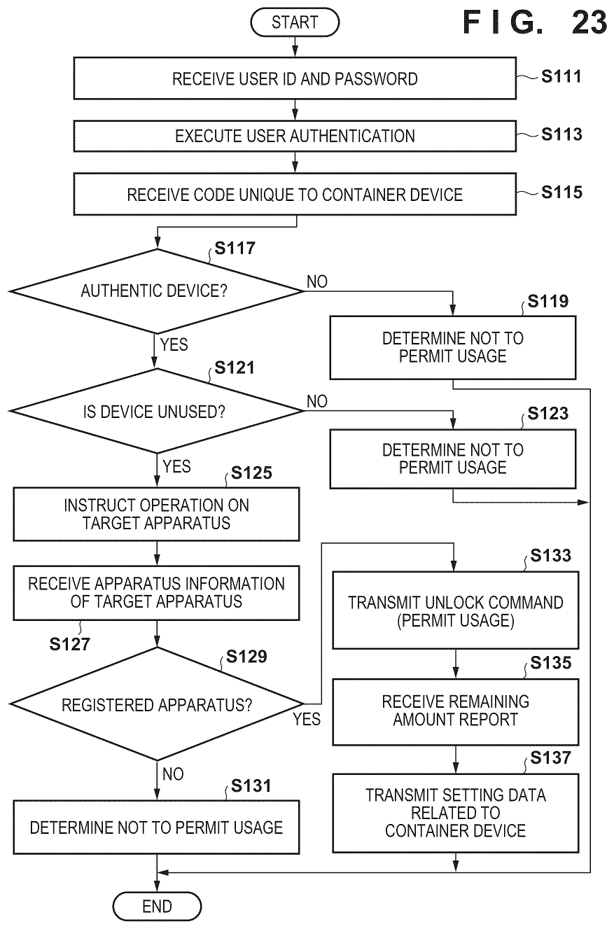

This section will describe several examples of flows of processing that may be executed in the image-forming system 1 according to the present embodiment with reference to sequence charts shown in FIGS. 20 to 22 and flowcharts shown in FIGS. 23 to 25B. Note that in the following explanation, a processing step will be abbreviated as S(Step).

### <6-1. Registration of Apparatus Information>

FIG. 20 is a sequence chart showing an example of a flow of schematic processing related to apparatus registration. The image-forming apparatus 100, the management server 300, and the user terminal 400 are mainly involved in the sequence shown in FIG. 20. Note that account information of a user has already been registered in the account table 310 of the management DB 303 prior to the start of the sequence.

First, in S11, the user inputs the user ID and password to, for example, a login screen provided by the application unit 440 of the user terminal 400. In S12, the application unit 440 transmits the input user ID and password to the management server 300 in order to log in. In S13, the authentication unit 370 of the management server 300 executes user authentication based on the user ID and password received from the user terminal 400. It is assumed here that the user authentication is successful and the login to the system is established. The subsequent processing shown in FIG. 20 is performed while the login session continues.

In S14, the user inputs the apparatus information including the apparatus ID of the image-forming apparatus 100 installed in the user environment E1 to, for example, the apparatus information input screen provided by the application unit 440. In S15, the application unit 440 transmits an apparatus registration request including the input apparatus information to the management server 300. In S16, the data management unit 350 registers the apparatus information included in the received apparatus registration request in the apparatus registration table 320. In S17, the data management unit 350 instructs the application unit 440 to display a message for prompting the user to perform a predetermined operation in the image-forming apparatus 100, and this message is displayed by the display device 415.

In S21, the user performs the predetermined operation on the user I/F 13 of the image-forming apparatus 100. Then, in S22, the lock control unit 97 of the image-forming apparatus 100 reads out the apparatus ID from the memory 12 and transmits the apparatus information including the readout apparatus ID to the management server 300. In S23, the data management unit 350 collates the apparatus ID included in the apparatus information received from the image-forming apparatus 100 with the apparatus ID registered in the apparatus registration table 320 in S16. If the apparatus IDs match, the data management unit 350 updates the value of corresponding “Status” in the apparatus registration table 320 to “Verified”. In S24, the data management unit 350 notifies the application unit 440 of the user terminal 400 of the result of the verification. The application unit 440 displays the notified verification result on the screen.

### <6-2. Provision of Container Device>

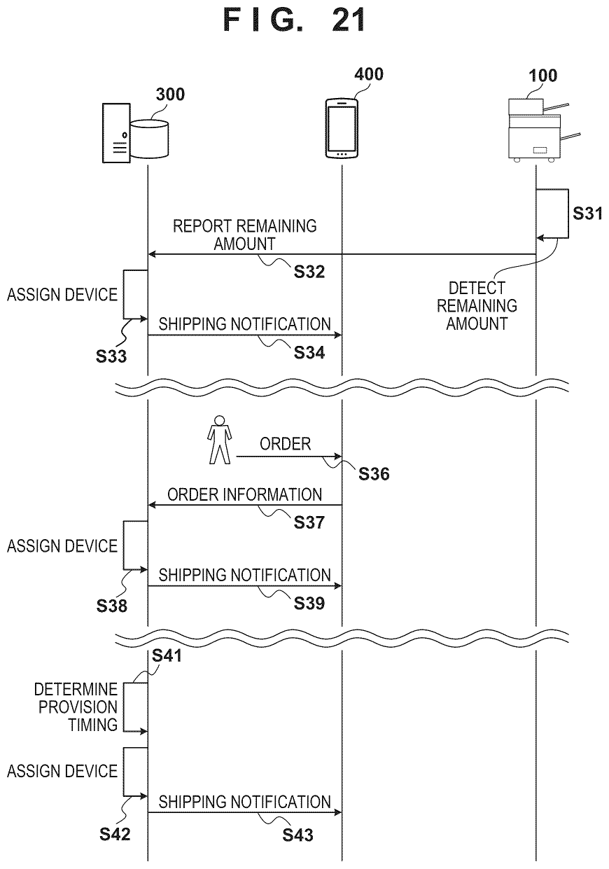

FIG. 21 is a sequence chart showing some examples of flows of schematic processing related to provision of container devices to users. The image-forming apparatus 100, the management server 300, and the user terminal 400 are mainly involved in the sequence shown in FIG. 21. Note that the provision management unit 360 of the management server 300 continuously monitors occurrence of a trigger event that triggers provision of a container device 200 to a user. Here, descriptions will be given with regard to a first example of trigger events that is a decrease in the remaining amount, a second example that is an order of a container device 200 from a user, and a third example that is arrival of a provision timing based on a regular purchase contract.

In the first example, in S31, the print control unit 96 of the image-forming apparatus 100 detects the remaining amount of toner or cartridge in the apparatus when, for example, an image-forming operation is performed. It is assumed here that the detected remaining amount has fallen below a remaining amount threshold that triggers provision of the new container device 200. In S32, the print control unit 96 reports the remaining amount information indicating the detected remaining amount to the management server 300. In S33, the provision management unit 360 of the management server 300 recognizes that the remaining amount of toner or cartridge in the image-forming apparatus 100 has decreased, and assigns a new container device 200 to the user who owns the image-forming apparatus 100. Assigning the container device 200 to the user can include adding a new record indicating the user ID and the device ID for identifying the container device 200 to the delivery device table 330. In addition, the provision management unit 360 transmits, to a delivery person, a message for instructing to deliver the assigned container device 200. When the new container device 200 is shipped to the user, the provision management unit 360 transmits, in S34, a shipping notification to the user terminal 400.

In the second example, in S36, a user accesses a website that sells container devices 200 using, for example, the user terminal 400, and orders a new container device 200. In S37, the user terminal 400 transmits, to the management server 300, order information indicating, for example, the type and number of ordered container devices 200. In S38, the provision management unit 360 of the management server 300 assigns the designated number of container devices 200 to the user who is the purchaser in response to the reception of the order information. In addition, the provision management unit 360 transmits, to a delivery person, a message for instructing to deliver the assigned container devices 200. After the container devices 200 are shipped to the user, the provision management unit 360 transmits, in S39, a shipping notification to the user terminal 400.

In the third example, in S41, the provision management unit 360 determines that the timing of providing a container device 200 has arrived for the user who has made the regular purchase contract. In S42, the provision management unit 360 assigns the new container device 200 to the user for whom the provision timing has arrived. In addition, the provision management unit 360 transmits, to a delivery person, a message for instructing to deliver the assigned container device 200. When the container device 200 is shipped to the user, the provision management unit 360 transmits, in S43, a shipping notification to the user terminal 400.

### <6-3. Use of Container Device Based on Authentication>

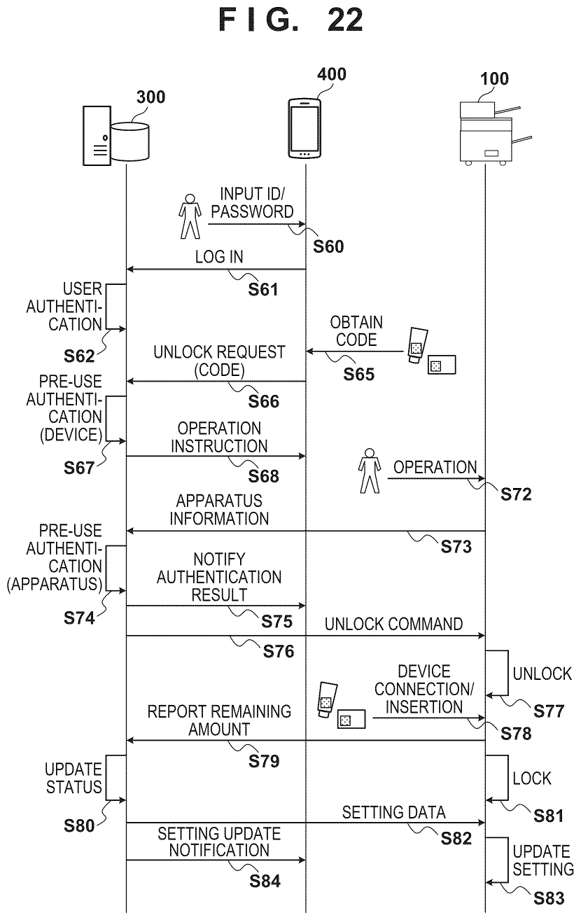

FIG. 22 is a sequence chart showing an example of a flow of schematic processing when the container device is used based on the pre-use authentication. The image-forming apparatus 100, the management server 300, and the user terminal 400 are mainly involved in the sequence shown in FIG. 22. It is assumed that an unused new container device 200 has been delivered to a user environment prior to the start of the sequence.

First, in S60, a user inputs the user ID and password to the login screen. In S61, the application unit 440 of the user terminal 400 transmits the input user ID and password to the management server 300. In S62, the authentication unit 370 of the management server 300 executes user authentication based on the user ID and password received from the user terminal 400. It is assumed here that the user authentication is successful and the login to the system is established. The subsequent processing shown in FIG. 22 is performed while the login session continues.

In S65, the application unit 440 activates the code obtainment unit 430 in response to an operation by the user. The code obtainment unit 430 obtains a code 201 unique to a container device 200 by, for example, optically reading the code using the camera 413, or by accepting a user input. Next, in S66, the application unit 440 transmits, to the management server 300, an unlock request including the code 201 obtained by the code obtainment unit 430.

The authentication unit 370 of the management server 300 starts the pre-use authentication in response to reception of the unlock request. S67 is a first stage of the pre-use authentication, in which the authentication unit 370 determines whether the container device 200 identified by the code 201 included in the unlock request has correspondence with the account of the login user by referring to the delivery device table 330. It is assumed here that the container device 200 has correspondence with the user account, and the first stage of the authentication is therefore successful. In response to the success of the first stage of the authentication, in S68, the authentication unit 370 instructs the application unit 440 to display a message for prompting the user to perform a predetermined operation in the target apparatus, and this message is displayed by the display device 415.

In S72, the user performs the predetermined operation on the user I/F 13 of the image-forming apparatus 100 that is the target apparatus. Then, in S73, the lock control unit 97 reads out the apparatus ID from the memory 12 and transmits the apparatus information including the readout apparatus ID to the management server 300. S74 is a second stage of the pre-use authentication, in which the authentication unit 370 determines whether the target apparatus has correspondence with the user account of the login user by referring to the apparatus registration table 320 based on the apparatus ID included in the received apparatus information. It is assumed here that the image-forming apparatus 100 has correspondence with the user account, and the second stage of the authentication is therefore also successful. In response to the success of the pre-use authentication, in S75, the authentication unit 370 notifies the user terminal 400 of the result indicating that the authentication is successful. In addition, in S76, the authentication unit 370 transmits an unlock command to the image-forming apparatus 100 to unlock the inhibiting mechanism 55 of the image-forming apparatus 100.

In S77, in response to reception of the unlock command from the management server 300, the lock control unit 97 of the image-forming apparatus 100 switches the state of the inhibiting mechanism 55 from the locked state to the unlocked state. In S78, the user replenishes the image-forming apparatus 100 with toner from the new container device 200 or inserts the new container device 200 into the image-forming apparatus 100 (or performs replacement). In S79, the print control unit 96 detects the remaining amount of toner or cartridge in the image-forming apparatus 100 and reports the remaining amount information to the management server 300. In S80, the data management unit 350 of the management server 300 updates the value of “Remaining Level” in the record of the apparatus registration table 320 corresponding to the image-forming apparatus 100 in response to reception of the remaining amount information. The data management unit 350 also changes “Status” in the record of the delivery device table 330 corresponding to the new container device 200 to “Used” or “In Use”. Meanwhile, when a predetermined unlocked period elapses after the reception of the unlock command, the lock control unit 97 of the image-forming apparatus 100 switches, in S81, the state of the inhibiting mechanism 55 from the unlocked state to the locked state.

In S82, the authentication unit 370 obtains, from the setting management table 340, the setting data associated with the container device 200 for which the pre-use authentication is successful, and transmits the obtained setting data to the image-forming apparatus 100. The transmitted setting data may be data associated with a combination of the container device 200 and the image-forming apparatus 100 as the target apparatus. In S83, the print control unit 96 of the image-forming apparatus 100 updates the settings of the operation conditions of the image-forming unit 40 by the setting data received from the management server 300 (stores the setting data in the predetermined storage region of the setting storage unit 95). In S84, the authentication unit 370 notifies the user terminal 400 of the update of the setting data in the image-forming apparatus 100.

Note that as described above, only the pre-use authentication concerning the container device 200 in S67 may be performed while the pre-use authentication concerning the image-forming apparatus 100 in S74 may be omitted. In this case, the user operation in S72 and the transmission of the apparatus information in S73 may also be skipped. However, if the power of the image-forming apparatus 100 is OFF, the image-forming apparatus 100 will not be able to receive the unlock command from the management server 300, and thus the management server 300 may instruct the user to power on the image-forming apparatus 100 in S68.

In addition, FIG. 22 shows an example in which the code 201 unique to the container device 200 is transmitted from the user terminal 400 to the management server 300 and the apparatus ID of the image-forming apparatus 100 is transmitted from the image-forming apparatus 100 to the management server 300, but the present embodiment is not limited to this. For example, the code 201 unique to the container device 200 may be forwarded to the image-forming apparatus 100 from the user terminal 400 that has obtained the code 201, and the image-forming apparatus 100 may relay the code 201 to the management server 300 together with the apparatus ID of the image-forming apparatus 100.

### <6-4. Authentication Processing>

FIG. 23 is a flowchart illustrating an example of a flow of the authentication processing executed by the management server 300. The authentication processing shown in FIG. 23 corresponds to the processing executed by the authentication unit 370 of the management server 300 in S62 to S76 of FIG. 22. This authentication processing may be realized by the processing circuit 304 executing a computer program stored in advance in the memory 302 of the management server 300, for example.

First, in S111, the authentication unit 370 receives the user ID and password input to the login screen. Next, in S113, the authentication unit 370 executes user authentication based on the received user ID and password. It is assumed here that the user authentication is successful, and a flow of processing performed when the user authentication has failed will not be described.

Next, in S115, the authentication unit 370 receives the code 201 unique to the container device 200 obtained in the user environment. Next, in S117, the authentication unit 370 determines whether the container device 200 identified based on the received code 201 has correspondence with the user account of the login user. For example, if there is an association between the device ID based on the received code 201 and the user ID of the login user registered in the delivery device table 330, the container device 200 is determined to be an authentic device, and the process advances to S121. On the other hand, if there is no association between the device ID based on the received code 201 and the user ID of the login user registered in the delivery device table 330, the process advances to S119.

In S119, the authentication unit 370 determines that the container device 200 is not a proper product provided through a regular route, and transmits, to the user terminal 400, an authentication result notification indicating that the use of the container device 200 is not permitted and the pre-use authentication has failed.

In S121, by referring to the delivery device table 330, the authentication unit 370 determines whether the status of the container device 200 identified by the received code 201 is “Unused”. If the status is “Unused”, the process advances to S125. On the other hand, if the status is not “Unused”, the process advances to S123.

In S123, since the container device 200 is not unused, the authentication unit 370 determines not to permit the use of the container device 200. In this case, the authentication unit 370 transmits, to the user terminal 400, an authentication result notification indicating that the use of the container device 200 is not permitted and the pre-use authentication has failed.

If the container device 200 identified by the received code 201 is a proper product and is unused, the authentication unit 370 instructs, in S125, the user to perform a predetermined operation on the target apparatus (for example, by displaying a message on the screen). Next, in S127, the authentication unit 370 receives the apparatus information including the apparatus ID from the image-forming apparatus 100 that is the target apparatus. Next, in S129, the authentication unit 370 determines whether the target apparatus identified by the received apparatus ID has already been registered (or both already been registered and verified) as an apparatus of the login user. For example, if there is an association between the received apparatus ID and the user ID of the login user registered in the apparatus registration table 320, the target apparatus has already been registered as an apparatus of the login user, and thus the process advances to S133. On the other hand, if there is no association between the received apparatus ID and the user ID of the login user registered in the apparatus registration table 320, the target apparatus has not been registered as an apparatus of the login user, and thus the process advances to S131.

In S131, since the target apparatus has not been registered as an apparatus of the login user, the authentication unit 370 determines not to permit the use of the container device 200 in the target apparatus. In this case, the authentication unit 370 transmits, to the user terminal 400, an authentication result notification indicating that the pre-use authentication has failed due to the apparatus being unregistered.

In S133, since the target apparatus has already been registered as an apparatus of the login user, the authentication unit 370 determines to permit the use of the container device 200 in the target apparatus. In this case, the authentication unit 370 transmits an unlock command to switch the inhibiting mechanism 55 of the image-forming apparatus 100 to the unlocked state, and also transmits, to the user terminal 400, an authentication result notification indicating that the authentication is successful. Next, in S135, the authentication unit 370 (or the data management unit 350) receives a remaining amount report indicating an increase in the remaining amount of toner or cartridge from the image-forming apparatus 100. Next, in S137, the authentication unit 370 obtains the setting data related to the container device 200 (or a combination of the container device 200 and the image-forming apparatus 100) from the setting management table 340, and transmits the obtained setting data to the image-forming apparatus 100. Then, the authentication processing shown in FIG. 23 ends.

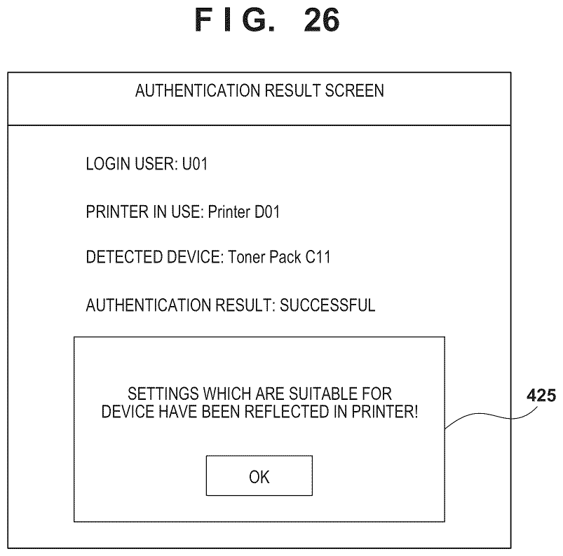

Note that the authentication unit 370 may transmit the setting data to the image-forming apparatus 100 together with the unlock command in S133, instead of transmitting the setting data to the image-forming apparatus 100 in S137, as described above. Furthermore, the authentication unit 370 may transmit, to the user terminal 400, a notification indicating that the setting data has been transmitted to the image-forming apparatus 100 (or the setting has successfully been updated in the image-forming apparatus 100). When the user terminal 400 becomes aware, through the notification, that the settings suitable for the container device 200 have been made in the image-forming apparatus 100, for example, a message 425 shown in FIG. 26 may be displayed by the display device 415. The image-forming apparatus 100 may also display the same message on the screen of the user I/F 13.

### <6-5. Lock Control Processing>

This section will describe two examples of flows of lock control processing executed by the image-forming apparatus 100. A first example corresponds to the above-described first configuration example of the image-forming apparatus 100, in which the use of the replenishment pack 200a is controlled in the image-forming apparatus 100a. A second example corresponds to the above-described second configuration example of the image-forming apparatus 100, in which the use of the cartridge 200b is controlled in the image-forming apparatus 100b.

### (1) First Example

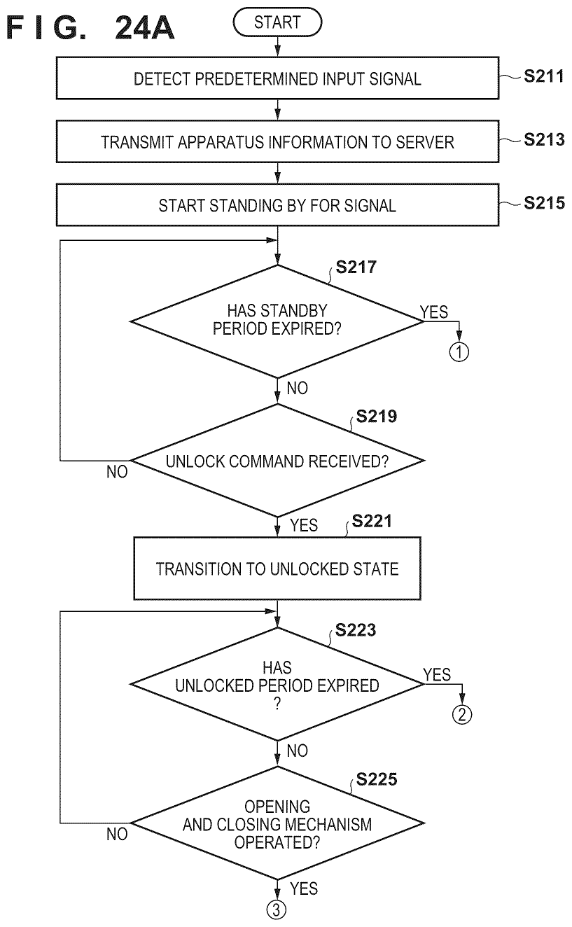

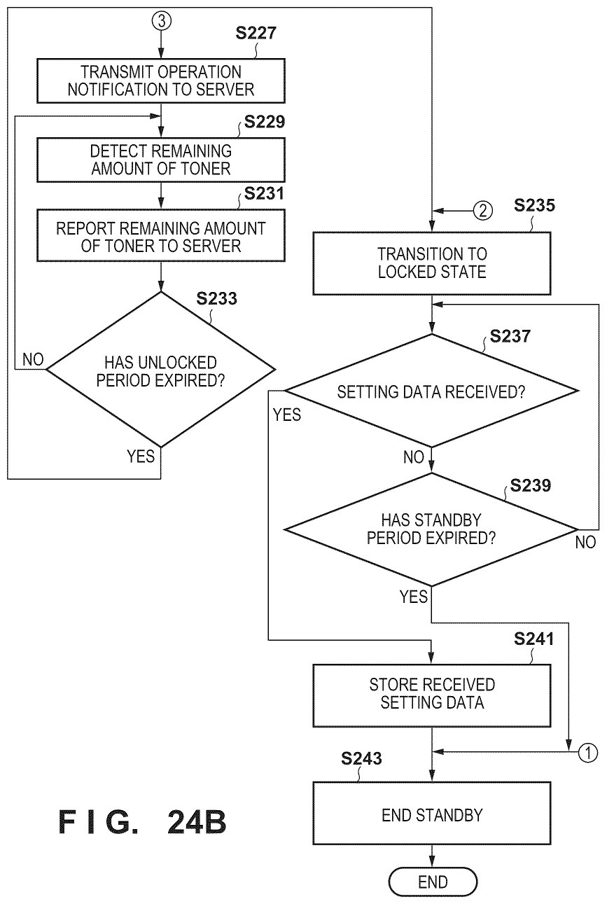

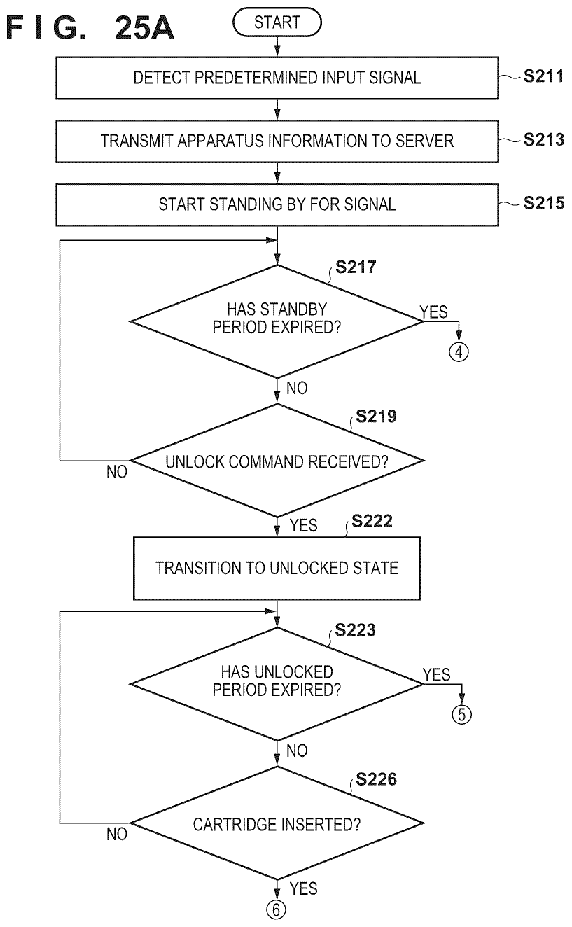

FIGS. 24A and 24B are flowcharts illustrating the first example of the flow of the lock control processing. The lock control processing corresponds to the processing executed by the lock control unit 97 of the image-forming apparatus 100a in S72 to S83 of FIG. 22. This lock control processing may be realized by the processing circuit 90 executing a computer program stored in advance in the memory 12 of the image-forming apparatus 100a, for example.

First, in S211, the lock control unit 97 detects a predetermined input signal. Here, the input signal may be, for example, an ID transmission request received from the user terminal 400 via the communication I/F 11, or a user input signal detected via the user I/F 13. In S213, in response to the detection of the predetermined input signal, the lock control unit 97 reads out the apparatus ID from the memory 12 and transmits the apparatus information including the readout apparatus ID to the management server 300. Next, in S215, the lock control unit 97 starts standing by for reception of an unlock command as a control signal based on the result of the pre-use authentication.

In S217, the lock control unit 97 determines whether a predetermined standby period has expired, by referring to, for example, the value of a timer that starts at the start of the standby. When the standby period has expired, the process advances to S243. On the other hand, when the standby period has not expired, the process advances to S219.

In S219, the process branches depending on whether an unlock command has been received from the management server 300. When an unlock command has been received from the management server 300, the process advances to S221. If no unlock command has been received, the process returns to S217.

In S221, the lock control unit 97 causes the inhibiting mechanism 55 to transition from the locked state to the unlocked state in accordance with the unlock command received from the management server 300. For example, the locking unit 130 is actuated to allow the user to operate the opening and closing mechanism. Next, in S223, the lock control unit 97 stands by until the unlocked period expires by using, for example, a timer that starts at the time of transitioning to the unlocked state. In the meantime, in S225, the lock control unit 97 monitors the operation of the opening and closing mechanism by the user. When the user operates the opening and closing mechanism to open the replenishment path, the process advances to S227.

In S227, the lock control unit 97 transmits, to the management server 300, an operation notification indicating that the replenishment path is open. In addition, in S229, the remaining amount detection unit 61 detects the remaining amount of toner in the preserving unit 48. Then, in S231, the print control unit 96 reports the remaining amount of toner detected by the remaining amount detection unit 61 to the management server 300. The detection and reporting of the remaining amount of toner in S229 and S231 may be repeated until it is determined in S233 that the unlocked period has expired.

If it is determined in S223 or S233 that the unlocked period has expired, the lock control unit 97 causes, in S235, the inhibiting mechanism 55 to transition from the unlocked state to the locked state.

Next, in S237, the lock control unit 97 stands by for reception of setting data related to the replenishment pack 200a for which the pre-use authentication is successful. While standing by for reception of the setting data, the lock control unit 97 determines in S239 whether the standby period has expired, by referring to, for example, the value of the timer. If the standby period has expired, the process advances to S243. If the setting data is received from the management server 300 before the standby period expires, the process advances to S241. Note that standing by for the setting data here may be started after a message indicating that the replenishment has succeeded (for example, the management server 300 becomes aware of the increase in the remaining amount of toner and the status of the replenishment pack 200a has been updated) is received from the management server 300.

In S241, the lock control unit 97 transfers, to the print control unit 96, the setting data received from the management server 300. The print control unit 96 stores the received setting data in the setting storage unit 95. Next, in S243, the lock control unit 97 ends the standby for signals and data. The lock control processing then ends.

When replenishment of toner from the replenishment pack 200a is complete, and the setting data stored in the setting storage unit 95 is updated, as described above, the respective members of the image-forming unit 40 operate in accordance with the operation parameters suitable for new toner at the time of execution of a print job thereafter.

### (2) Second Example

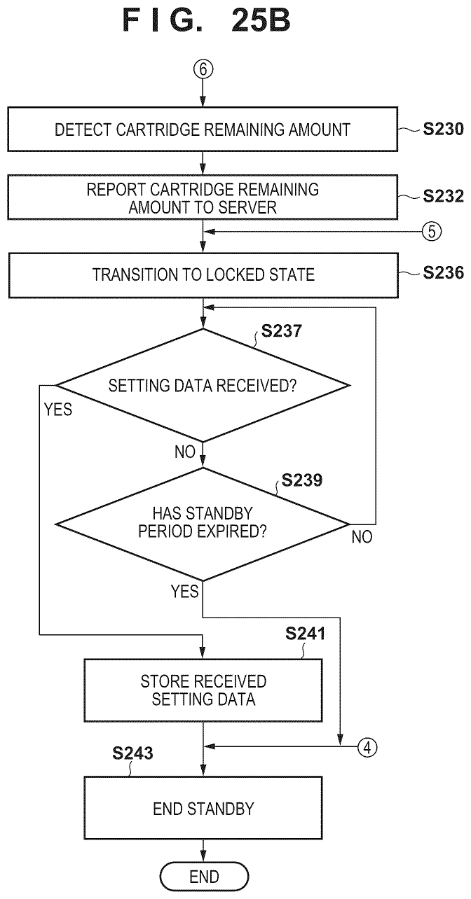

FIGS. 25A and 25B are flowcharts illustrating the second example of the flow of the lock control processing. The lock control processing corresponds to the processing executed by the lock control unit 97 of the image-forming apparatus 100b in S72 to S83 of FIG. 22. This lock control processing may be realized by the processing circuit 90 executing a computer program stored in advance in the memory 12 of the image-forming apparatus 100b, for example.

S211 to S219 as processing steps related to transmission of apparatus information and standby for an unlock command may be the same as those in the first example described with reference to FIGS. 24A and 24B and repetitive descriptions thereof will be omitted. If an unlock command is received from the management server 300 in S219, the process advances to S222.

In S222, the lock control unit 97 causes the inhibiting mechanism 55 to transition from the locked state to the unlocked state in accordance with the unlock command received from the management server 300. For example, the locking unit 160 is actuated to allow the user to access the insertion path of the cartridge. Next, in S223, the lock control unit 97 stands by until the unlocked period expires by using, for example, a timer that starts at the time of transitioning to the unlocked state. In the meantime, in S226, the lock control unit 97 monitors extraction of an existing cartridge and insertion of a new cartridge by the user. When the user inserts a new cartridge, the process advances to S230.

In S230, the remaining amount of the cartridge inserted into the image-forming apparatus 100b is detected. Then, in S232, the print control unit 96 reports the detected remaining amount of the cartridge to the management server 300. After that, in S236, the lock control unit 97 causes the inhibiting mechanism 55 to transition from the unlocked state to the locked state.

Next, in S237, the lock control unit 97 stands by for reception of setting data related to the cartridge for which the pre-use authentication is successful. While standing by for reception of the setting data, the lock control unit 97 determines in S239 whether the standby period has expired, by referring to, for example, the value of the timer. If the standby period has expired, the process advances to S243. If the setting data is received from the management server 300 before the standby period expires, the process advances to S241.

In S241, the lock control unit 97 transfers, to the print control unit 96, the setting data received from the management server 300. The print control unit 96 stores the received setting data in the setting storage unit 95. Next, in S243, the lock control unit 97 ends the standby for signals and data. The lock control processing then ends.

When insertion of a new cartridge into the image-forming apparatus 100b is complete, and the setting data is updated, as described above, the respective members of the image-forming unit 40 operate in accordance with the operation parameters suitable for the new cartridge and a consumable material in the cartridge at the time of execution of a print job thereafter.

### 7. Summary

Thus far, embodiments, practical examples, and alteration examples of the technology according to the present disclosure have been described with reference to FIGS. 1 to 26. According to the above-described embodiments, the inhibiting mechanism capable of inhibiting supply of the consumable material from the container device to the image-forming apparatus or insertion of the container device into the image-forming apparatus is disposed in at least one of the container device and the image-forming apparatus. The code unique to the container device to be used is obtained by the terminal present in the user environment, and transmitted to the server apparatus in the remote environment. The server apparatus performs authentication for permitting the use of the container device in the image-forming apparatus based on the aforementioned code. When the authentication is successful, the inhibiting mechanism is switched to a state in which it is possible to supply the consumable material or insert the container device, and setting data related to the container device is provided from the server apparatus and set in the image-forming apparatus. Accordingly, the setting data suitable for the container device or the supplied consumable material can be set for image formation in the image-forming apparatus under a situation in which it is ensured that the use of the container device is legitimate. Since it is unnecessary to mount a large-capacity or high-end memory in the container device, it is possible to reduce the cost of manufacturing the container devices, thereby reducing the running cost borne by users. In addition, the use of the container device and the provision of the setting data can be permitted or rejected in consideration of a condition that would be difficult to be determined by an image-forming apparatus alone, such as correspondence between a container device and a user account or correspondence between a target apparatus and a user account.

Furthermore, according to the above-described embodiments, the setting data related to the container device is data associated with at least one of the individual container device and the type of the container device. Therefore, even if a condition that influences the characteristic of the consumable material or the device has changed at the time of manufacturing a container device, the server apparatus can configure the image-forming apparatus by providing it with the setting data so that it can perform an optimum image-forming operation regardless of the influence of the change. As an example, the setting data related to the container device may be data further associated with at least one of the individual image-forming apparatus and the type of the image-forming apparatus. In this case, since optimum operation parameters for a combination of the image-forming apparatus and the container device to be used are set in the image-forming apparatus, it will be possible to provide users with higher-quality print images. By inhibiting use of a container device for which the authentication has failed and providing appropriate setting data, it is possible to reduce the risk of malfunction and prolong the product life.

According to the above-described embodiments, the code unique to the container device is a code that is printed on a device or on a package thereof and can optically be read or can be read by a human user. Therefore, before physically connecting or inserting the device, a user can readily obtain the code using an UI or a camera provided in an operation terminal of an image-forming apparatus or a user terminal, thereby requesting authentication.

Note that, in the image-forming system 1 shown in FIG. 1, a user uses a user terminal 400 that is separate from the image-forming apparatus 100. However, the functions of the above-described user terminal 400 may be integrated into the image-forming apparatus 100. That is, an operation terminal additionally provided in the image-forming apparatus 100 may provide the same code obtainment function as the above-described code obtainment unit 430 of the user terminal 400 and the same UI function as the application unit 440.

The embodiments, practical examples, and alteration examples described in this specification may be combined with each other in any way. The features described in connection with a given example, and the advantageous effects thereof are applicable to any embodiment, practical example, and alteration example unless otherwise explained.

### 8. Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The invention claimed is:

1. An image-forming system comprising:
an image-forming apparatus present in a user environment and configured to form an image on a recording medium using a consumable material in a container device;
image-forming apparatus and capable of inhibiting supply of the consumable material from the container device to the image-forming apparatus or insertion of the container device into the image-forming apparatus;
an obtainment unit configured to obtain a code unique to the container device in a state in which the inhibiting mechanism inhibits the supply of the consumable material or the insertion of the container device;
a server apparatus present in a remote environment and configured to perform authentication for the container device based on the code obtained by the obtainment unit; and
a first an inhibiting mechanism disposed in at least one of the container device and the
control unit present in the user environment and configured to set, in a case where the authentication performed by the server apparatus is successful, setting data related to the container device received from the server apparatus in the image-forming apparatus.

2. The image-forming system according to claim 1, further comprising:
a second control unit present in the user environment and configured to switch, in a case where the authentication performed by the server apparatus is successful, the inhibiting mechanism to a state in which the supply of the consumable material or the insertion of the container device is possible.

3. The image-forming system according to claim 1, wherein the image-forming apparatus includes
a storage unit configured to store the setting data related to the container device received from the server apparatus.

4. The image-forming system according to claim 3, wherein the storage unit includes
a first storage region in which the setting data related to the container device received from the server apparatus is stored, and
a second storage region in which default setting data that is usable before the authentication is stored.

5. The image-forming system according to claim 3, wherein the storage unit includes a storage region having initial setting data stored at the time of shipment of the image-forming apparatus, that is overwritten by the setting data related to the container device received from the server apparatus.

6. The image-forming system according to claim 1, wherein the setting data related to the container device is data associated with at least one of the individual container device and a type of the container device.

7. The image-forming system according to claim 6, wherein the setting related to the container device is data further associated with at least one of the individual image-forming apparatus and a type of the image-forming apparatus.

8. The image-forming system according to claim 1, wherein the server apparatus is configured to receive account information of a user, and
the authentication performed by the server apparatus includes determining whether the container device identified by the code has correspondence with an account indicated by the account information.

9. The image-forming system according to claim 8, further comprising:
a database configured to indicate an association between each account and at least one container device provided to a user having the account,
wherein, in a case where the container device identified by the code is associated with an account indicated by the account information in the database, the server apparatus is configured to determine that the container device has correspondence with the account.

10. The image-forming system according to claim 9, wherein the image-forming apparatus is configured to:
store, in advance, apparatus identification information identifying the image-forming apparatus; and
transmit, in a case where a predetermined input signal is detected, the apparatus identification information to the server apparatus, and
the authentication performed by the server apparatus further includes determining whether the image-forming apparatus identified by the apparatus identification information has correspondence with the account.

11. The image-forming system according to claim 10, wherein the database is further configured to indicate an association between each account and at least one image-forming apparatus registered as an apparatus of a user having the account, and
in a case where the image-forming apparatus identified by the apparatus identification information is associated with an account indicated by the account information in the database, the server apparatus is configured to determine that the image-forming apparatus has correspondence with the account.

12. The image-forming system according to claim 1, wherein the container device is a device configured to be temporarily connected to the image-forming apparatus when the consumable material is supplied to the image-forming apparatus.

13. The image-forming system according to claim 1, wherein the container device is a cartridge inserted into the image-forming apparatus.

14. The image-forming system according to claim 1, wherein the image-forming apparatus is configured to form the image on the recording medium by performing one or more operations of:
a charging operation of charging an image carrier;
an exposure operation of forming an electrostatic latent image on the image carrier by exposing the image carrier with light;
a developing operation of supplying a developing agent to the electrostatic latent image to obtain a developing agent image;
a transfer operation of transferring the developing agent image to the recording medium; and
a fixing operation of fixing the developing agent image onto the recording medium by heating the developing agent image on the recording medium, and
the setting data includes at least one operation parameter to be used in the one or more operations.

15. The image-forming system according to claim 14, wherein the container device is a process cartridge including a member configured to perform at least one of the one or more operations.

16. The image-forming system according to claim 1, wherein the code is an optically-readable code printed on the container device or a package of the container device, and
the obtainment unit is configured to obtain the code by optically reading the code.

17. The image-forming system according to claim 1, wherein the obtainment unit is configured to obtain the code input by a user via a user interface.

18. The image-forming system according to claim 1, wherein the image-forming system comprises a user terminal including the obtainment unit and a communication unit configured to transmit the code obtained by the obtainment unit to the server apparatus.

19. The image-forming system according to claim 1, wherein the image-forming apparatus includes the obtainment unit, a communication unit configured to transmit the code obtained by the obtainment unit to the server apparatus, and the first control unit.

20. A method for managing use, at an image-forming apparatus, of a consumable material in a container device,
wherein an inhibiting mechanism capable of inhibiting supply of the consumable material from the container device to the image-forming apparatus or insertion of the container device into the image-forming apparatus is disposed in at least one of the container device and the image-forming apparatus, and
the image-forming apparatus is present in a user environment,
the method comprising:
obtaining, by an obtainment unit present in the user environment, a code unique to the container device in a state in which the inhibiting mechanism inhibits the supply of the consumable material or the insertion of the container device;
transmitting the obtained code from the obtainment unit to a server apparatus present in a remote environment;
performing, by the server apparatus, authentication for the container device based on the code transmitted by the obtainment unit;
in a case where the authentication performed by the server apparatus is successful, transmitting setting data related to the container device from the server apparatus to the image-forming apparatus so as to cause the image-forming apparatus to store the setting data.

21. An image-forming apparatus installed in a user environment, comprising:
an image-forming unit configured to form an image on a recording medium using a consumable material in a container device;
a storage unit configured to store setting data to be used for image formation by the image-forming unit;
a processing circuit configured to control an inhibiting mechanism capable of inhibiting supply of the consumable material from the container device to the image-forming apparatus or insertion of the container device into the image-forming apparatus; and
a communication interface configured to communicate with a server apparatus present in a remote environment,
wherein the processing circuit is configured to:
in a state in which the inhibiting mechanism inhibits the supply of the consumable material or the insertion of the container device, obtain a code unique to the container device to transmit the obtained code to the server apparatus via the communication interface, and
in a case where authentication for the container device performed by the server apparatus based on the transmitted code is successful, store, in the storage unit, setting data related to the container device received from the server apparatus via the communication interface.

22. A server apparatus for managing use, at an image-forming apparatus, of a consumable material in a container device,
wherein at least one of the container device and the image-forming apparatus includes an inhibiting mechanism capable of inhibiting supply of the consumable material from the container device to the image-forming apparatus or insertion of the container device into the image-forming apparatus,
the image-forming apparatus is present in a user environment and the server apparatus is present in a remote environment,
the server apparatus comprising a communication interface and a processing circuit,
wherein the processing circuit is configured to:
receive a code unique to the container device from an apparatus present in the user environment via the communication interface in a state in which the inhibiting mechanism inhibits the supply of the consumable material or the insertion of the container device;
perform authentication for the container device based on the received code; and
in a case where the authentication for the container device is successful, transmit setting data related to the container device to the image-forming apparatus via the communication interface.
